(19) United States
(12) Patent Application Publication
(10) Pub. No.: US 2026/0197138 A1
(43) Pub. Date: Jul. 9, 2026

(54) SYNCHRONIZATION FOR MOBILITY

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/412,743

(22) Filed: Dec. 8, 2025

Related U.S. Application Data
(60) Provisional application No. 63/742,302, filed on Jan. 6, 2025.

(51) Int. Cl. H04L 5/00

(52) U.S. Cl. CPC H04L 5/005; H04L 5/0091

(57) ABSTRACT

Methods and apparatuses for synchronization for mobility. A method performed by a user equipment (UE) includes receiving information related to event-driven synchronization for mobility, receiving one or more first reference signals (RSs) associated with one or more first candidate cells, and determining, from the one or more first RSs, whether to trigger a transmission of an indicator. The method further includes, in response to a determination to trigger the transmission, transmitting the indicator and receiving one or more second RSs associated with one or more second candidate cells, and obtaining, from the one or more second RSs, synchronization for the one or more second candidate cells.

### CROSS-REFERENCE TO RELATED AND CLAIM OF PRIORITY

The present application claims priority under 35 U.S.C. § 119(e) to U.S. Provisional Patent Application No. 63/742,302 filed on Jan. 6, 2025, which is hereby incorporated by reference in its entirety.

### TECHNICAL FIELD

The present disclosure relates generally to wireless communication systems and, more specifically, the present disclosure relates to methods and apparatuses for synchronization for mobility.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to synchronization for mobility.

In one embodiment, a user equipment (UE) is provided. The UE includes a transceiver configured to receive information related to event-driven synchronization for mobility; and receive one or more first reference signals (RSs) associated with one or more first candidate cells. The UE further includes a processor operably coupled with the transceiver, the processor configured to determine, from the one or more first RSs, whether to trigger a transmission of an indicator. The transceiver is further configured to, in response to a determination to trigger the transmission, transmit the indicator and receive one or more second RSs associated with one or more second candidate cells. The processor is further configured to obtain, from the one or more second RSs, synchronization for the one or more second candidate cells.

In another embodiment, a base station (BS) is provided. The BS includes a processor; and a transceiver operably coupled with the processor. The transceiver is configured to transmit information related to event-driven synchronization for mobility, transmit one or more first RSs associated with one or more first candidate cells, receive an indicator, wherein transmission of the indicator is triggered based on the one or more RSs, and transmit one or more second RSs associated with one or more second candidate cells. The one or more second RSs indicate synchronization information for the one or more second candidate cells.

In yet another embodiment, a method performed by a UE is provided. The method includes receiving information related to event-driven synchronization for mobility, receiving one or more first RSs associated with one or more first candidate cells, and determining, from the one or more first RSs, whether to trigger a transmission of an indicator. The method further includes, in response to a determination to trigger the transmission, transmitting the indicator, receiving one or more second RSs associated with one or more second candidate cells, and obtaining, from the one or more second RSs, synchronization for the one or more second candidate cells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of. A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of a protocol stack of NR networks according to embodiments of the present disclosure;

FIG. 8 illustrates an example functional split option for protocol stacks according to embodiments of the present disclosure;

FIG. 9 illustrates an example protocol stack with two functional split points according to embodiments of the present disclosure;

FIG. 10 illustrates an example primary synchronization signal (PSS)/secondary synchronization signal (SSS)/physical broadcast channel (PBCH) (SSB) block according to embodiments of the present disclosure;

FIG. 11 illustrates an example type-1 random access procedure according to embodiments of the present disclosure;

FIG. 12 illustrates an example type-2 random access procedure according to embodiments of the present disclosure;

FIG. 13 illustrates an example of PG-based mobility according to embodiments of the present disclosure;

FIG. 14 illustrates an example cell configuration according to embodiments of the present disclosure;

FIG. 15 illustrates an example of mobility for the UE of FIG. 14 according to embodiments of the present disclosure;

FIG. 16 illustrates an example procedure to support (early) synchronization for L1 seamless mobility according to embodiments of the present disclosure;

FIG. 17 illustrates another example procedure to support (early) synchronization for L1 seamless mobility according to embodiments of the present disclosure;

FIG. 18 illustrates yet another example procedure to support UE-initiated (early) synchronization for L1 seamless mobility according to embodiments of the present disclosure; and

FIG. 19 illustrates an example method performed by a UE in a wireless communication system according to embodiments of the present disclosure.

### DETAILED DESCRIPTION

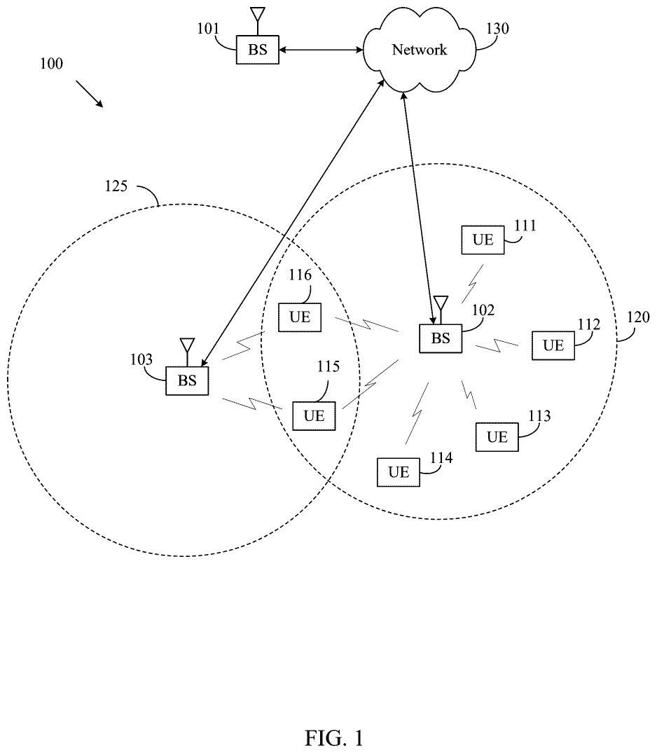

FIGS. 1-19, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4]3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing synchronization for mobility. In certain embodiments, one or more of the BSs 101-103 include circuitry, programing, or a combination thereof to support synchronization for mobility.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

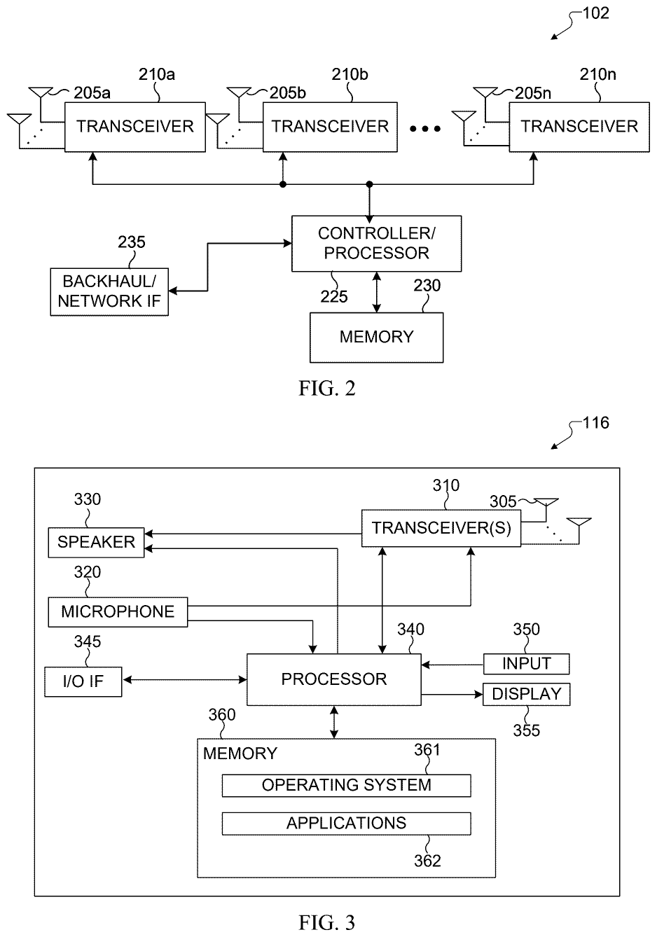

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting synchronization for mobility. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize synchronization for mobility as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

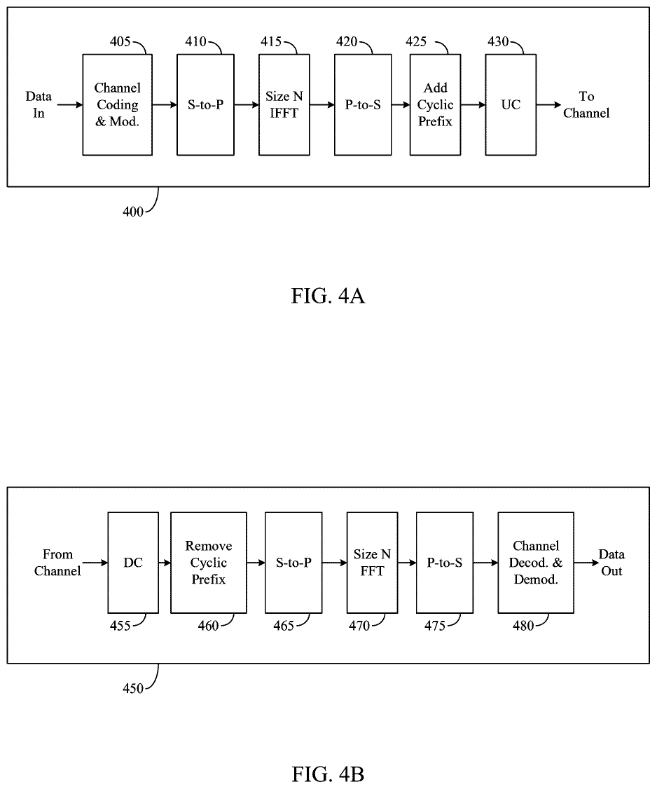

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support synchronization for mobility as described in embodiments of the present disclosure. In some embodiments, the receive path 450 is configured to support synchronization for mobility as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

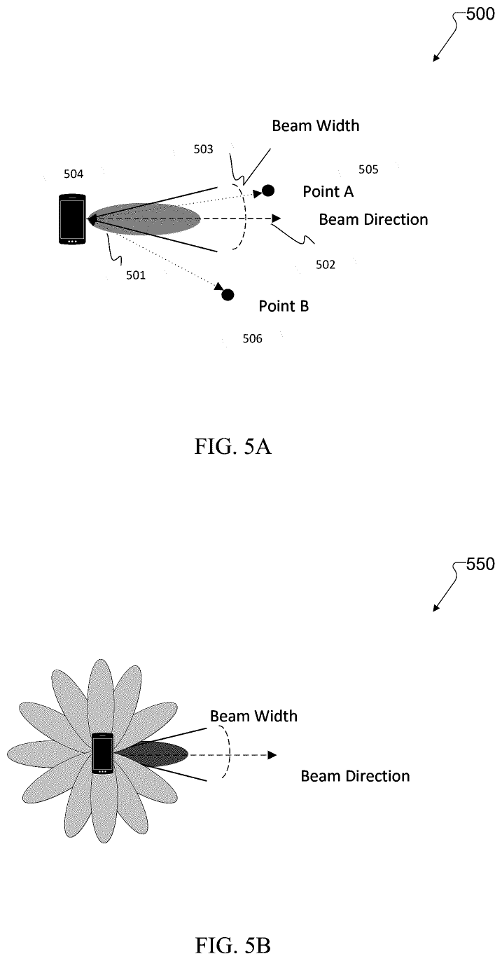

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

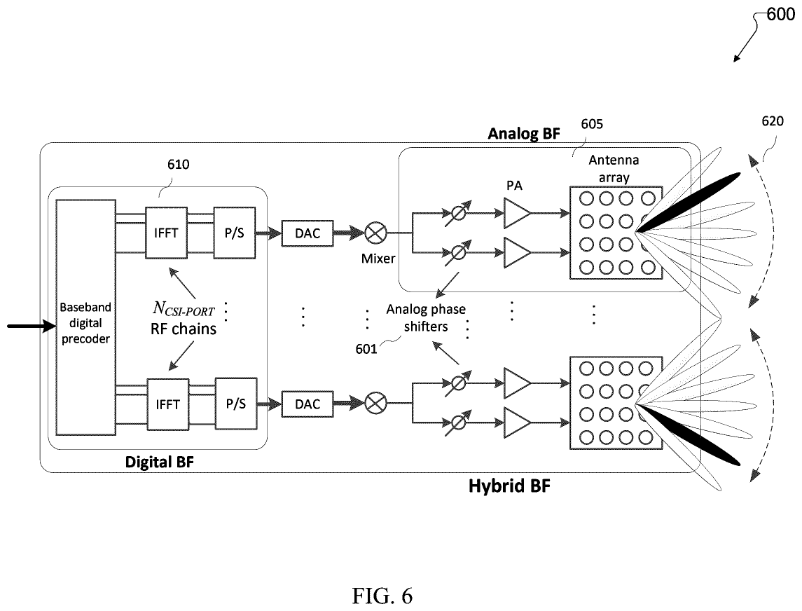

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of,
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that in (up to Rel.17) the NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g., for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various resource allocation and association methods to enable the UE-initiated/event-driven beam reporting as well. Furthermore, the present disclosure provides various design aspects and therefore corresponding solutions for the case(s) where the UE receives the network's response(s) during the UE-initiated/event-driven beam operation/management process.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g., channel quality indicator (CQI) report interval (CRI), SSB resource indicator (SSBRI)) and Jᵢ is a beam metric (e.g., L1-reference signal received power (RSRP), L1-signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
   beam (TCI state) TCI states (e.g., DL TCI state, UL TCI state, or unified (joint) DL/UL TCI state), or
   panel(s) (e.g., UE panels for DL reception or/and UL transmission), or
   antenna(e) (e.g., UE antennae for DL reception or/and UL transmission), or
   antenna port(s) (e.g., UE antenna ports for DL reception or/and UL transmission).
In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/beam/ | (A) | Yes (e.g., non-CSI-related | No |
| TDCP | | event) | |
| | (B) | No | Yes |
| | (C) | Yes (e.g., non-CSI-related | Yes |
| | | event) | |
| 4. other (content-free/ | (A) | Yes (no need for content) | No |
| less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| | Trigger/pre-notification | |
|---|---|---|
| Report-type | message | Content |
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), content-specific or | No |
| | event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| | Trigger/pre-notification | |
|---|---|---|
| Type | message | Content |
| 0 | Yes (content- | No |
| | agnostic/transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g., beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g., CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g., MCS, or number of CWs.
For another example, when there is no pre-notification message/trigger associated with a content, i.e., the report-type is (B), the content can be transmitted using UL resource(s) configured (e.g., configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
   In another example, a DCI could be used to indicate to the UE a beam (i.e., a TCI state and/or a TCI state ID) for the transmission/reception of a PDCCH or a PDSCH
   For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 01, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (main or indicated) TCI state is TCI state of UE-dedicated reception on PDSCH/PDCCH or dynamic-grant/configured-grant based PUSCH and all of dedicated PUCCH resources. In this disclosure, a TCI state can be referred to as a spatial resource unit.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state (TCI state code point) indicated/included in a DL related DCI format or UL related DCI format is applied after a beam application time from the corresponding HARQ-ACK feedback.

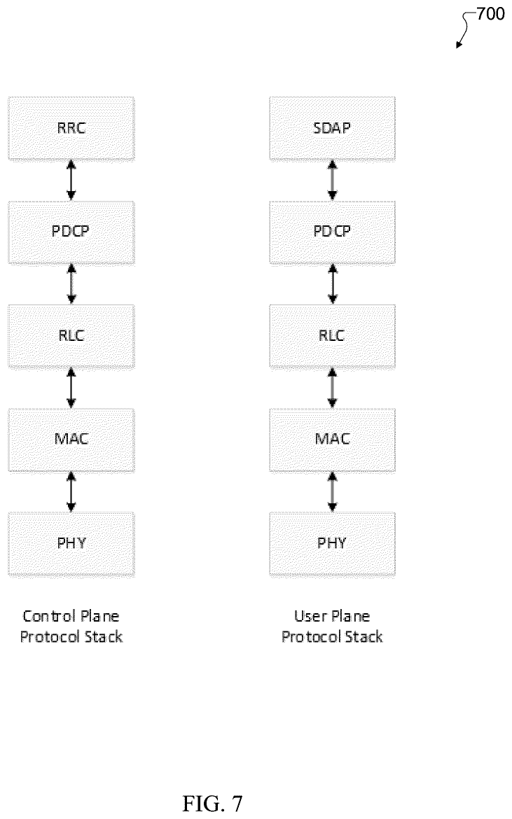

FIG. 7 illustrates an example of a protocol stack of NR networks 700 according to embodiments of the present disclosure. The example protocol stack 700 shown in FIG. 7 is for illustration only and other embodiments can be used without departing from the scope of the present disclosure.

FIG. 7 illustrates an example of the protocol stack of NR networks including a physical (PHY) layer, a medium access control (MAC) layer, a radio link control (RLC) layer, a packet data convergence protocol (PDCD) layer, for control plane there is radio resource control (RRC) layer, and for user plane there is service data adaptation protocol (SDAP) layer.

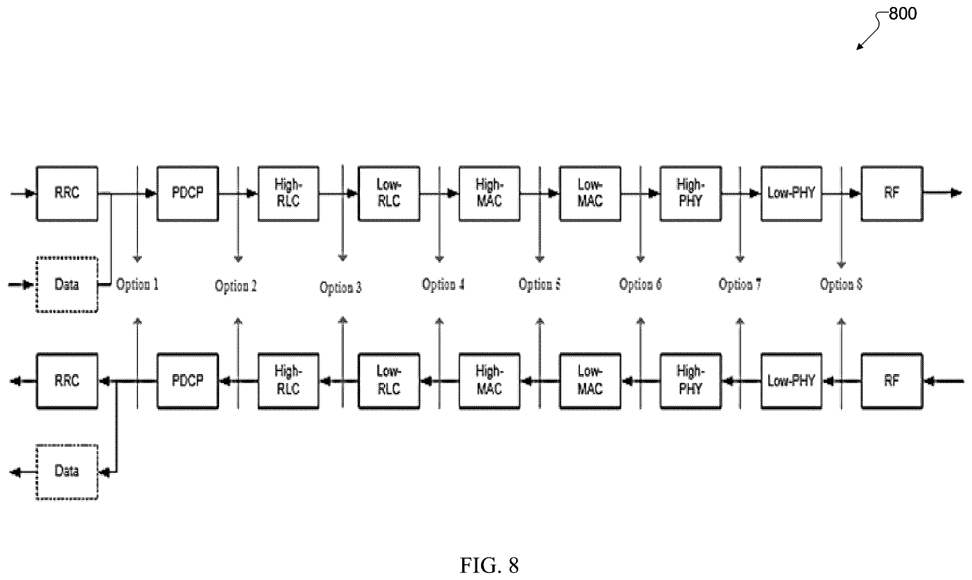

FIG. 8 illustrates an example functional split option for protocol stacks 800 according to embodiments of the present disclosure. The example functional split option for protocol stacks 800 shown in FIG. 8 is for illustration only and other embodiments can be used without departing from the scope of the present disclosure.

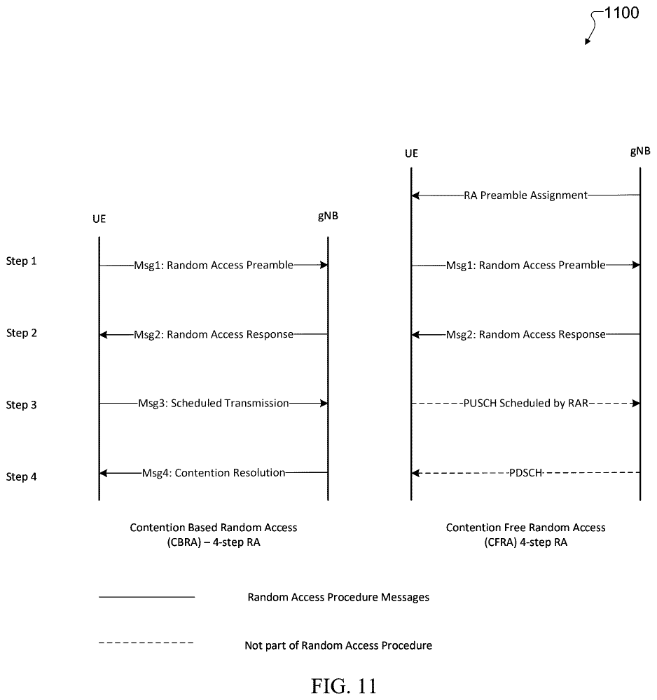

There can be different mappings of the layers of the protocol stack to actual devices implementing these functionalities. In one example, all layers of the protocol stack can be mapped to a single device. In another example, the layers of the protocol stack can be split across multiple devices. 3GPP [TR 38.801] considered different functional split points between a central unit (CU) containing the higher layers of the protocol stack and a distributed unit (DU) containing the lower layers of the protocol stack. The functional split options considered by 3GPP are illustrated in FIG. 7 (TR 38.801—FIG. 11.1.1-1). For example, with functional split option 2, a CU contains the RRC and PDCP layers, while a DU contains the RLC, MAC and PHY layers.

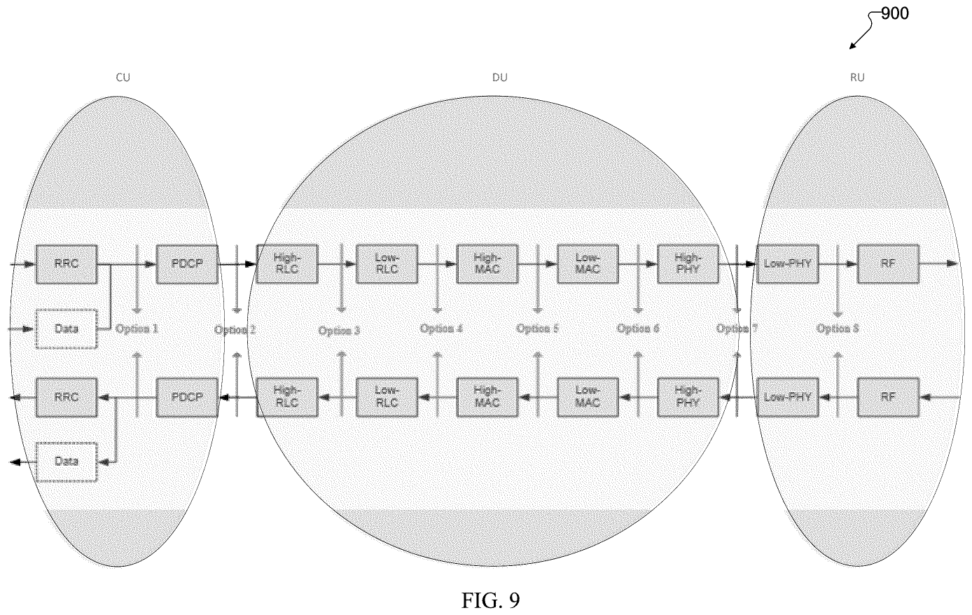

FIG. 9 illustrates an example protocol stack with two functional split points 900 according to embodiments of the present disclosure. The example protocol stack with two functional split points 900 shown in FIG. 9 is for illustration only and other embodiments can be used without departing from the scope of the present disclosure.

Multiple split options are also possible, for example, in additional to the higher layer split between the CU and DU (e.g., functional split option 2), there can be a split within the DU. For example, the DU can be split into DU and remote unit (RU). The O-RAN alliance has been considering a lower layer functional split, where the lower PHY and the RF reside in a remote unit (RU), while the higher PHY and layers above reside in the DU or CU. The lower level split being considered by the O-RAN alliance is similar to functional split option 7 of FIG. 8. There are various sub-options being considered for option 7 to define where the split occurs within the physical layer occurs. FIG. 9 illustrates an example protocol stack with two functional split points, the first between the CU and the DU and the second between the DU and the RU.

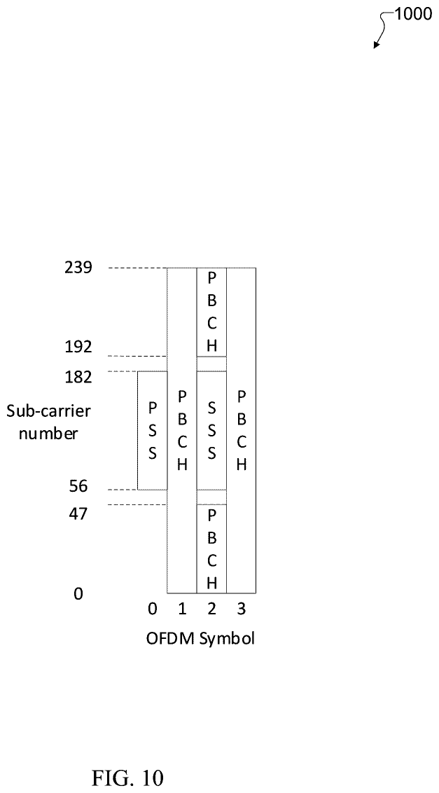

FIG. 10 illustrates an example SSB block 1000 according to embodiments of the present disclosure. The example SSB block 1000 shown in FIG. 10 is for illustration only and other embodiments can be used without departing from the scope of the present disclosure.

In NR/5G, a geographical area served by the network can be partitioned into cells as aforementioned. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

In NR/5G, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 physical resource blocks (240 subcarriers), as illustrated in FIG. 10.

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 11 illustrates an example type-1 random access procedure 1100 according to embodiments of the present disclosure. The example type-1 random access procedure 1100 shown in FIG. 11 is for illustration only and other embodiments can be used without departing from the scope of the present disclosure.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 11;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

A type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

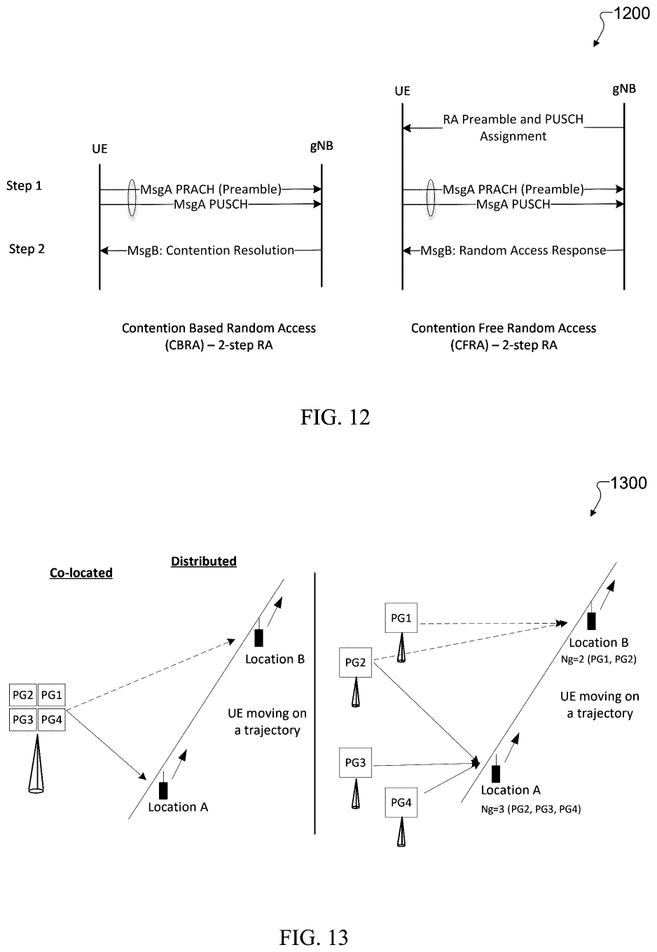

FIG. 12 illustrates an example type-2 random access procedure 1200 according to embodiments of the present disclosure. The example type-2 random access procedure 1200 shown in FIG. 12 is for illustration only and other embodiments can be used without departing from the scope of the present disclosure.

Rel-16, introduced a new random access procedure; Type-2 random access procedure, also known as 2-step random access procedure (2-step RACH), is as illustrated in FIG. 12, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

FIG. 13 illustrates an example of PG-based mobility 1300 according to embodiments of the present disclosure. The example of PG-based mobility 1300 shown in FIG. 13 is for illustration only and other embodiments can be used without departing from the scope of the present disclosure.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. Alternatively, (2) can be PG-based mobility, as illustrated in FIG. 13. While the user moves from a location A to another location B, the set of PGs is updated from {PG2, PG3, PG4} to {PG1, PG2}. Consequently, a seamless beam-based (as opposed to cell-based) mobility is possible especially for RRC-connected UEs.

Embodiments of the present disclosure recognize that to improve handover procedures, 3GPP introduced several handover enhancements which include:
Dual Active Protocol Stack (DAPS): The source gNB connection is maintained, i.e., a UE continues DL data reception from the source gNB and UL data transmission to the source gNB, after reception of the RRC message for handover, and until the source gNB is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE switches to the target cell following the cell switch command. The benefit of cell switch command is to reduce handover latency.

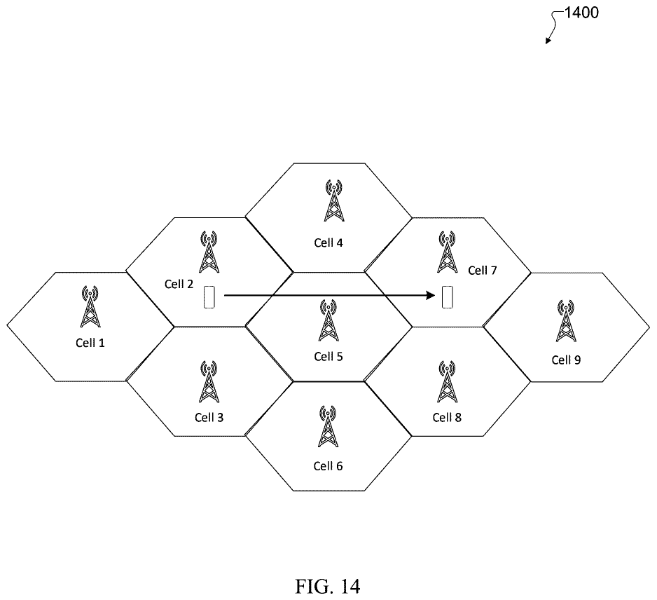

FIG. 14 illustrates an example cell configuration 1400 according to embodiments of the present disclosure. The example cell configuration 1400 shown in FIG. 14 is for illustration only and other embodiments can be used without departing from the scope of the present disclosure.

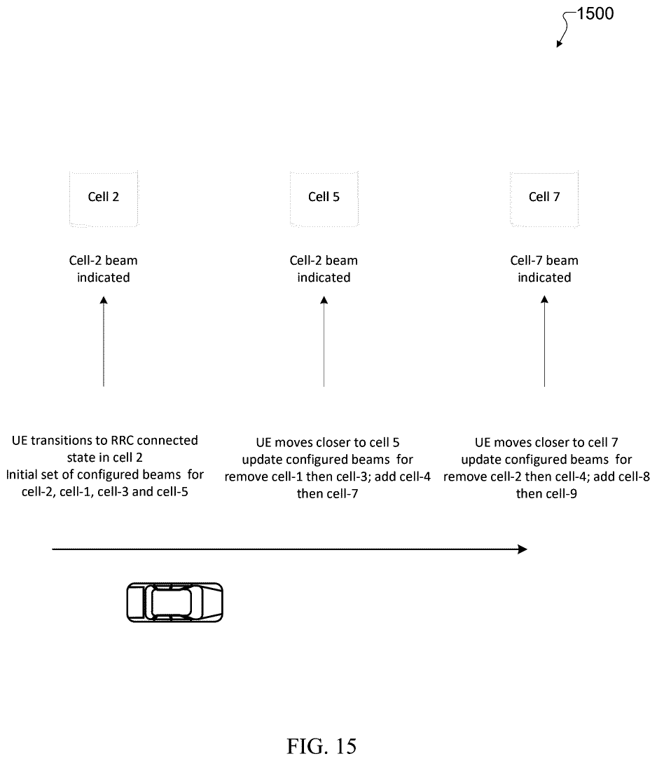

FIG. 15 illustrates an example of mobility 1500 for the UE of FIG. 14 according to embodiments of the present disclosure. The example of mobility 1500 shown in FIG. 15 is for illustration only and other embodiments can be used without departing from the scope of the present disclosure.

FIG. 15 illustrates one example of mobility for the UE of FIG. 14. The UE transitions to the connected mode in cell 2. The UE can be configured with beams or TCI states associated with the cells in the neighborhood of the UE. For example, these can be beams or TCI states associated with cell-1, cell-3 and cell-5 in addition to cell-2. A configuration with a beam or TCI state is used, for example, to mean one or more of the following:
Configuration with a reference signal (e.g., CSI-RS or SSB) used for beam measurement, wherein the reference signal is associated with a spatial domain filter corresponding to a beam.
Configuration with a reference signal (e.g., CSI-RS or SSB) used for beam or TCI state indication, wherein the reference signal is associated with a QCL or spatial domain filter corresponding to a beam or TCI state.
Configuration with a TCI state or spatial relation information used for beam indication, wherein the TCI state or spatial relation information can include a reference signal for (1) quasi-co-location (QCL) (e.g., QCL Type A or Type B or Type C or Type D), or (2) spatial relation information/beam indication, and the reference signal is associated with a spatial domain filter or QCL type corresponding to a beam.

The UE can provide measurement reports for the configured beams or TCI states (e.g., measurement reference signals). Based on measurements/measurement reports, the network (e.g., gNB), and/or the UE can activate a subset of beams (e.g., reference signals or TCI states as aforementioned). Furthermore, based on the measurements/measurement reports, the network (e.g., gNB), and/or the UE can indicate and/or activate one or more beams (e.g., reference signals or TCI states as aforementioned). As the UE moves, the configured beams can be updated. For example, as the UE moves closer to cell 5 and into cell 5, configured beams can be added for cell 4 and cell 7, and configured beams can be removed for cell 1 and cell 3. Based on the updated configuration of beams and measurement reports, beams are activated or deactivated and new beams can be indicated to UE through which the UE communicates with the network. For example, as the UE moves closer to cell 5, the indicated beam (e.g., TCI state or reference signal) can be associated with cell 5. In a variant example, a UE can be simultaneously indicated two beams or TCI states for cell 2 and cell 5, e.g., using CJT across cells 2 and 5. As the UE moves closer to cell 7 and into cell 7, configured beams can be added for cell 8 and cell 9, and configured beams can be removed for cell 2 and cell 4. Based on the updated configuration of beams or TCI states and measurement reports, beams or TCI states are activated or deactivated and new beams or TCI states can be indicated to UE through which the UE communicates with the network. For example, as the UE moves closer to cell 7, the indicated beam (e.g., TCI state or reference signal) can be associated with cell 7. In a variant example, a UE can be simultaneously indicated two beams or TCI states for cell 5 and cell 7, e.g., using CJT across cells 5 and 7. In this example, the UE changes the cell(s) (or TRP(s) or RU(s)) through which it communicates to the network based on beam (e.g., reference signal) measurement and reporting and beam (e.g., TCI state) indication (e.g., beam-based mobility).

In the example of FIG. 15, the configuration (e.g., initial configuration and/or addition and/or removal) of beams (e.g., measurement reference signals, or beam indication reference signals or TCI states or spatial resource units), can be following the examples of this disclosure based on (1) UE-dedicated or UE-specific signaling (e.g., RRC signaling or MAC CE signaling or L1 control signaling), or (2) UE-common (e.g., to a group of UEs or UEs in a cell or associated with an entity), using e.g., SIB signaling (e.g., common channels from the cell the UE is communicating with the network through or a neighbor cell), or RRC signaling or MAC CE signaling or L1 control signaling.

In one example, the reference signal for beam or TCI state indication when the UE is in connected mode (e.g., when the UE is within a cell or when the UE is moving between cells (mobility)) can be separate (e.g., has separate configuration) from the reference signal for initial beam acquisition, e.g., when the UE is transitioning to the connected mode.

In one example, the reference signal for beam or TCI state indication when the UE is in connected mode (e.g., when the UE is within a cell or when the UE is moving between cells (mobility)) can be from the same configuration as the reference signal for initial beam acquisition, e.g., when the UE is transitioning to the connected mode.

In NR, there are different levels of abstraction for beam or TCI state indication and antenna port indication, which adds unnecessary complexity to MIMO and beam indication. To simplify beam and/or antenna port indication, a spatial resource unit is considered as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [TS 38.211]. A UE can be indicated with one or more spatial resource units. In the case of seamless mobility, the spatial resource units can belong to different cells, e.g., for CJT.

For application of a spatial resource unit, the spatial resource unit can be first activated, and then indicated. The activation of a spatial resource unit allows the UE time to measure the spatial resource unit and be ready to use it when it is indicated. The indication of the spatial resource unit is when the UE is signaled to use (e.g., for transmission or reception) the spatial resource unit. A UE can be configured multiple spatial resource units, in different cells. As the UE moves through the network, the configured spatial resource units can be updated as UE moves away from some cells and towards other cells. The multiple spatial resource units can be in a same set, or in different sets, for example one set for DL and/or joint spatial resource units and one set for UL spatial resource units. The UE can then be activated one or more of the spatial resource units. The spatial resource units can be activated in a single set or in multiple sets. The UE can then be indicated one or more spatial resource units from the activated spatial resource units. In a variant example, there is no activation of spatial resource units, the configured spatial resource units can be directly indicated.

In this disclosure a spatial resource unit is defined as a reference signal (e.g., a reference signal with one antenna port) or an antenna port of a reference signal of a cell or RU. A spatial resource unit is identified by an ID (e.g., spatial resource unit ID). In one example, one set of spatial resource units is configured or re-configured across multiple cells or RUs. In another example, different sets of spatial resource units are configured or re-configured for different cells or RUs, the spatial resource unit can contain an ID of a cell or RU, and an ID of spatial resource unit within the set of spatial resource units configured for the cell or RU. A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID. A spatial resource unit can be referred to as a reference signal, hence, a spatial resource unit ID can be referred to as a reference signal ID.

Embodiments of the present disclosure recognize that to enable/support seamless mobility, there is a need for efficient yet effective early (DL and/or UL) synchronization mechanism(s) to be implemented as both the network and UE sides so that any interruption time related to synchronization can be minimized.

Accordingly, embodiments of the present disclosure provide various design aspects related to reducing latency and overhead of signaling associated with mobility and disruption time due to mobility, and improving reliability and resilience for users in connected mode in a network. In particular, this disclosure specifies means of (early) synchronization between the network and users for seamless mobility.

A UE could determine or identify, e.g., the UE could be provided or configured or activated or indicated by the network, e.g., via/in/by higher layer RRC signaling(s)/parameter(s) CSI-ReportConfig and/or CSI-ResourceConfig and/or MAC CE command(s) and/or dynamic DCI based L1 signaling(s) based on or according to a corresponding UE's capability or capability signaling, one or more sets of RSs or RS resources (e.g., in terms/form of their respective RS/resource IDs/indexes) for beam measurement/reporting, activation and/or indication to support or enable seamless mobility—throughout the present disclosure, a RS or RS resource could correspond to or could be referred to as a SSB e.g. provided by SSB-Index or a NZP CSI-RS resource or resource configuration e.g. provided by NZP-CSI-RS-Resource, and could be associated or linked or mapped to a cell configured/associated with an entity ID (e.g., a PCI); in particular,
In one example, the UE could determine or identify, e.g., the UE could be provided or configured by the network, e.g. via/in/by higher layer RRC signaling(s)/parameter(s) CSI-ReportConfig and/or CSI-ResourceConfig, a set of one or more RSs or RS resources (e.g., in terms/form of their respective RS/resource ID/index) each associated/linked to a cell (represented by an entity ID e.g. a PCI) in the network:
   For example, higher layer parameter(s)/signaling(s) e.g. nzp-CSI-RS-ResourceSet that provides or configures the set of RS(s) or RS resource(s) could comprise, provide, configure, include, contain or indicate a set of one or more entity IDs (e.g., having the same number of entries or the same length as the set of RS(s) or RS resource(s)); in this case, each of the RS(s) or RS resource(s) in the set could be associated, mapped or linked to an entity ID in the set of entity ID(s). For instance, the first (or last) entry (hence the corresponding RS/RS resource) or the RS/RS resource with the lowest (or highest) resource ID/index in/of the set of RS(s) or RS resource(s) could be mapped, linked or associated to the first entry (hence the corresponding entity ID) in/of the set of entity ID(s), the second (or second last) entry (hence the corresponding RS/RS resource) or the RS/RS resource with the second lowest (or second highest) resource ID/index in/of the set of RS(s) or RS resource(s) could be mapped, linked or associated to the second entry (hence the corresponding entity ID) in/of the set of entity ID(s), and so on, and the last (or first) entry (hence the corresponding RS/RS resource) or the RS/RS resource with the highest (or lowest) resource ID/index in/of the set of RS(s) or RS resource(s) could be mapped, linked or associated to the last entry (hence the corresponding entity ID) in/of the set of entity ID(s)
   For another example, higher layer parameter(s)/signaling(s) e.g. NZP-CSI-RS-Resource that provides or configures a RS or RS resource in the set could comprise, provide, configure, include, contain or indicate an entity ID; in this case, the RS or RS resource in the set could then be mapped, linked or associated to the entity ID.
   For another example, when/if a RS or RS resource e.g. a SSB that is quasi-co-located (QCL'ed)—e.g., of QCL-TypeD—with a RS or RS resource in the set is associated, linked or mapped to an entity ID, the RS or RS resource in the set could be associated, linked or mapped to the entity ID.
   For another example, the UE could determine or identify a RS or RS resource (e.g., in terms/form of its RS/resource ID or index) in the set as one or more of:
      a QCL source RS or RS resource e.g. a NZP CSI-RS resource or resource configuration provided or indicated in a TCI state; in this case, the RS or RS resource (or equivalently the QCL source RS or RS resource herein) could be associated with an entity ID when/if (i) higher layer parameter(s)/signaling(s) e.g. TCI-State that provides or configures or indicates the TCI state comprises, includes, provides, configures or contains the entity ID, and/or (ii) a QCL root RS or RS resource e.g. a SSB that is quasi-co-located (QCL'ed)—e.g., of QCL-TypeD—with the RS or RS resource (or equivalently the QCL source RS herein) is associated, linked or mapped to the entity ID according to or following those specified herein in the present disclosure
      a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in a TCI state; in this case, the RS or RS resource (or equivalently the QCL root RS or RS resource herein) could be associated with an entity ID when/if (i) higher layer parameter(s)/signaling(s) e.g. TCI-State that provides or configures or indicates the TCI state comprises, includes, provides, configures or contains the entity ID, and/or (ii) the QCL source RS or RS resource herein is associated, linked or mapped to the entity ID according to or following those specified herein in the present disclosure

For these design example, the UE could receive from the network, e.g., via/in/by higher layer RRC signaling(s)/parameter(s) and/or MAC CE command(s) and/or dynamic DCI based L1 signaling(s) based on or according to a corresponding UE's capability or capability signaling, one or more indicators (denoted by transition signaling(s) throughout the present disclosure) to add, remove, activate/deactivate and/or update one or more of the RSs or RS resources in the set (hence one or more cells in the network) to support or enable seamless mobility.
For example, the one or more indicators could be via/by/in higher layer RRC signaling(s)/parameters, and comprise one or more candidate RS or RS resource IDs/indexes and/or the corresponding entity IDs; in this case, the one or more indicators could add the one or more candidate RSs or RS resources—e.g., in terms/form of their RS/resource IDs or indexes—to the set of RS(s) or RS resource(s); alternatively, the one or more indicators could remove RS(s) or RS resource(s) that has the same/identical RS/resource ID(s)/index(es) as that for/of the candidate RS(s) or RS resource(s) from the set of RS(s) or RS resource(s).
For another example, the one or more indicators could be via/by/in a MAC CE activation/deactivation command and/or a DCI, and comprise a bitmap (e.g., having the same number of entries as the number of RS(s)/RS resource(s) in the set) and/or one or more corresponding entity IDs; in this case, each entry/bit position of the bitmap could correspond to a RS or RS resource (e.g., in form/terms of its RS/resource ID/index) in the set. When/if an entry/bit position of the bitmap is set to ‘1’ (or ‘0’), the corresponding RS or RS resource in the set could be activated or deactivated for beam measurement/reporting, activation and/or indication for seamless mobility. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE activation/deactivation command and/or a DCI, and comprise a bitmap (e.g., having the same number of entries as the number of RS(s)/RS resource(s) in a list/pool of RS(s)/RS resource(s)—e.g., in terms/form of the corresponding RS/resource ID(s)/index(es)—higher layer configured or provided to the UE) and/or one or more corresponding entity IDs; in this case, each entry/bit position of the bitmap could correspond to a RS or RS resource (e.g., in form/terms of its RS/resource ID/index) in the list/pool. When/if an entry/bit position of the bitmap is set to ‘1’ (or ‘0’), the corresponding RS or RS resource in the list/pool could correspond to a RS or RS resource in the set. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE indication command and/or a DCI, and comprise one or more candidate RS or RS resource IDs/indexes and/or the corresponding entity IDs; in this case, the UE could use or apply the indicated or provided candidate RS(s) or RS resource(s) as the set of RS(s) or RS resource(s) for seamless mobility. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE indication command and/or a DCI, and comprise a bitmap (e.g., having the same number of entries as the number of RS(s)/RS resource(s) in the set), one or more candidate RS or RS resource IDs/indexes and/or the corresponding entity IDs; in this case, each entry/bit position of the bitmap could correspond to a RS or RS resource (e.g., in form/terms of its RS/resource ID/index) in the set and an indicated or provided candidate RS or RS resource (e.g., in form/terms of its RS/resource ID/index). When/if an entry/bit position of the bitmap is set to ‘1’ (or ‘0’), the corresponding RS or RS resource in the set could be updated or replaced by the corresponding candidate RS or RS resource. When/if the signaling medium is DCI, the one or more indicators could be indicated or realized via/by a new/dedicated DCI field and/or repurposing one or more codepoints of one or more existing DCI fields in/of the corresponding DCI format(s).

Furthermore, a UE could keep monitoring, tracking, measuring and/or assessing one or more of the RSs or RS resources in the set, e.g., their radio link qualities and/or L1 beam qualities such as L1-RSRPs/L1-SINRs, during the UE's movement through/across cells in the network.
In another example, the UE could determine or identify, e.g., the UE could be provided or configured by the network, e.g. via/in/by higher layer RRC signaling(s)/parameter(s) CSI-ReportConfig and/or CSI-ResourceConfig, one or more sets of RSs or RS resources each comprising one or more RSs or RS resources (e.g., in terms/form of their respective RS/resource ID/index); in this case, each set could be associated/linked to a cell (represented by an entity ID e.g. a PCI) in the network:
   For example, one or more of the RSs or RS resources—e.g., in terms/form of their RS/resource IDs/indexes—in a (or each) set could be associated/linked to one or more cells (and therefore the corresponding entity IDs) in the network. The UE could determine or identify the association(s)/linkage(s) between the corresponding RS(s)/RS resource(s) in a (each) set and the corresponding entity ID(s) according to or following those specified herein in the present disclosure (e.g., following or according to those specified or defined in the above described design examples).
   For another example, higher layer parameter(s)/signaling(s) e.g. CSI-ResourceConfig that provides or configures the one or more sets of RS(s) or RS resource(s) could comprise, provide, configure, include, contain or indicate a set of one or more entity IDs (e.g., having the same number of entries as the number of set(s)); in this case, each of the set(s)—and therefore, the RS(s) or RS resource(s) in terms/form the corresponding RS/resource ID(s)/index(es) therein—could be associated, mapped or linked to an entity ID in the set of entity ID(s). For instance, the first (or last) set or the set associated with the lowest (or highest) set ID/index could be mapped, linked or associated to the first entry (hence the corresponding entity ID) in/of the set of entity ID(s), the second (or second last) set or the set associated with the second lowest (or second highest) set ID/index could be mapped, linked or associated to the second entry (hence the corresponding entity ID) in/of the set of entity ID(s), and so on, and the last (or first) set or the set associated with the highest (or lowest) set ID/index could be mapped, linked or associated to the last entry (hence the corresponding entity ID) in/of the set of entity ID(s).
   For another example, higher layer parameter(s)/signaling(s) e.g. nzp-CSI-RS-ResourceSet that provides or configures a RS or RS resource set could comprise, provide, configure, include, contain or indicate an entity ID; in this case, the RS or RS resource set (hence the corresponding RS(s) or RS resource(s) e.g. in terms/form the corresponding RS/resource ID(s)/index(es) therein) could then be mapped, linked or associated to the entity ID.
   For another example, when/if RS(s) or RS resource(s) e.g. SSB(s) that is/are quasi-co-located (QCL'ed)—e.g., of QCL-TypeD—with at least one RS or RS resource in a set is/are associated, linked or mapped to an entity ID, the RS or RS resource set (hence the corresponding RS(s) or RS resource(s) in terms/form the corresponding RS/resource ID(s)/index(es) therein) could be associated, linked or mapped to the entity ID.
   For another example, the UE could determine or identify at least one RS or RS resource (e.g., in terms/form of its RS/resource ID or index) in a set as one or more of:
      QCL source RS(s) or RS resource(s) e.g. NZP CSI-RS resource(s) or resource configuration(s) provided or indicated in TCI state(s); in this case, the RS or RS resource set (hence the corresponding at least one RS or RS resource, or equivalently the QCL source RS(s) or RS resource(s) therein) could be associated with an entity ID when/if (i) higher layer parameter(s)/signaling(s) e.g. TCI-State(s) that provides or configures or indicates the TCI state(s) comprises, includes, provides, configures or contains the entity ID, and/or (ii) QCL root RS(s) or RS resource(s) e.g. SSB(s) that is/are quasi-co-located (QCL'ed)—e.g., of QCL-TypeD—with the at least one RS or RS resource (or equivalently the QCL source RS(s) herein) in the set is associated, linked or mapped to the entity ID according to or following those specified herein in the present disclosure
      QCL root RS(s) or RS resource(s) e.g. SSB(s) quasi-co-located (QCL'ed)—e.g., of QCL-TypeD—with one or more RSs or RS resources serving/configured as QCL source RS(s) e.g. NZP CSI-RS resource(s) or resource configuration(s) provided or indicated in TCI state(s); in this case, the RS or RS resource set (hence the corresponding at least one RS or RS resource, or equivalently the QCL root RS(s) or RS resource(s) therein) could be associated with an entity ID when/if (i) higher layer parameter(s)/signaling(s) e.g. TCI-State(s) that provides or configures or indicates the TCI state(s) comprises, includes, provides, configures or contains the entity ID, and/or (ii) the QCL source RS or RS resource herein is associated, linked or mapped to the entity ID according to or following those specified herein in the present disclosure

For these design example, the UE could receive from the network, e.g., via/in/by higher layer RRC signaling(s)/parameter(s) and/or MAC CE command(s) and/or dynamic DCI based L1 signaling(s) based on or according to a corresponding UE's capability or capability signaling, one or more indicators (denoted by transition signaling(s) throughout the present disclosure) to add, remove, activate/deactivate and/or update one or more of RSs or RS resources in a set and/or one or more of the RS or RS resource sets (hence one or more cells in the network) to support or enable seamless mobility.
For example, the UE could follow those specified or defined herein in the present disclosure (e.g., those specified or defined in the above described design examples) to determine or identify the RS(s) or RS resource(s) for beam measurement/reporting, activation and/or indication for seamless mobility when/if the one or more indicators are to add, remove, activate/deactivate and/or update one or more of RSs or RS resources in a RS or RS resource set.
For another example, the one or more indicators could be via/by/in higher layer RRC signaling(s)/parameters, and comprise one or more candidate RS or RS resource set IDs/indexes (each associated/configured for/with a candidate RS or RS resource set comprising one or more RSs or RS resources in terms/form of the corresponding RS/resource ID(s)/index(es)) and/or the corresponding entity IDs; in this case, the one or more indicators could add the one or more candidate RS or RS resource sets—e.g., in terms/form of their resource set IDs/indexes—to the (existing) RS or RS resource set(s); alternatively, the one or more indicators could remove RS or RS resource set(s) that has the same/identical resource set ID(s)/index(es) as that for/of the candidate RS or RS resource set(s) from the existing set(s) of RS(s) or RS resource(s).
For another example, the one or more indicators could be via/by/in a MAC CE activation/deactivation command and/or a DCI, and comprise a bitmap (e.g., having the same number of entries as the number of RS or RS resource set(s)) and/or one or more corresponding entity IDs; in this case, each entry/bit position of the bitmap could correspond to a RS or RS resource set (e.g., in form/terms of its RS or RS resource set). When/if an entry/bit position of the bitmap is set to ‘1’ (or ‘0’), the corresponding RS or RS resource set (and therefore the corresponding RS(s) or RS resource(s) in the set) could be activated or deactivated for beam measurement/reporting, activation and/or indication for seamless mobility. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE activation/deactivation command and/or a DCI, and comprise a bitmap (e.g., having the same number of entries as the number of RS or RS resource set(s) in a list/pool of RS or RS resource set(s)—e.g., in terms/form of the corresponding RS or RS resource set ID(s)/index(es)—higher layer configured or provided to the UE) and/or one or more corresponding entity IDs; in this case, each entry/bit position of the bitmap could correspond to a RS or RS resource set (e.g., in form/terms of its RS or RS resource set ID/index) in the list/pool. When/if an entry/bit position of the bitmap is set to ‘1’ (or ‘0’), the corresponding RS or RS resource set in the list/pool could correspond to a RS or RS resource set used for beam measurement/reporting, activation and/or indication for seamless mobility. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE indication command and/or a DCI, and comprise one or more candidate RS or RS resource set IDs/indexes (each associated/configured for/with a candidate RS or RS resource set comprising one or more RSs or RS resources in terms/form of the corresponding RS/resource ID(s)/index(es)) and/or the corresponding entity IDs; in this case, the UE could use or apply the indicated or provided candidate RS or RS resource set(s) as the set(s) of RS(s) or RS resource(s) for seamless mobility. When/if the signaling medium is DCI, the one or more indicators could be indicated or realized via/by a new/dedicated DCI field and/or repurposing one or more codepoints of one or more existing DCI fields in/of the corresponding DCI format(s).
For another example, the one or more indicators could be via/by/in a MAC CE indication command and/or a DCI, and comprise a bitmap (e.g., having the same number of entries as the number of RS or RS resource set(s)), one or more candidate RS or RS resource set IDs/indexes (each associated/configured for/with a candidate RS or RS resource set comprising one or more RSs or RS resources in terms/form of the corresponding RS/resource ID(s)/index(es)) and/or the corresponding entity IDs; in this case, each entry/bit position of the bitmap could correspond to a (existing) RS or RS resource set (e.g., in form/terms of its RS or RS resource set ID/index) and an indicated or provided candidate RS or RS resource set (e.g., in form/terms of its RS or RS resource set ID/index). When/if an entry/bit position of the bitmap is set to ‘1’ (or ‘0’), the corresponding RS or RS resource in the set could be updated or replaced by the corresponding candidate RS or RS resource. When/if the signaling medium is DCI, the one or more indicators could be indicated or realized via/by a new/dedicated DCI field and/or repurposing one or more codepoints of one or more existing DCI fields in/of the corresponding DCI format(s).

Furthermore, a UE could keep monitoring, tracking, measuring and/or assessing one or more of the RSs or RS resources in the set, and/or one or more of the RS or RS resource sets, e.g., their radio link qualities and/or L1 beam qualities such as L1-RSRPs/L1-SINRs, during the UE's movement through/across cells in the network.

Throughout the present disclosure, an entity ID could correspond to one of: a PCI, a PCI index pointing to an entry (or a PCI) from a list/set/pool of PCIs higher layer configured/provided to the UE, a ARFCN value, an sub-carrier spacing (SCS) index, a cyclic prefix (CP) index, a TCI state ID/index, a (CSI) resource setting/configuration ID, a CSI reporting setting/configuration ID, a (CSI) resource set ID/index, a (CSI-RS) resource ID/index, a CORESET group/pool index value (e.g. provided by coresetPoolIndex or coresetGroupIndex), a RNTI (e.g., a C-RNTI (for PDCCH order), a RA-RNTI, and/or etc.) and/or etc.

According to or following those specified/described herein in the present disclosure, to support or enable seamless mobility, a UE may need to keep monitoring, tracking, measuring and/or assessing one or more of the RSs or RS resources in the set (denoted by target RS(s) or RS resource(s))—determined or identified e.g. provided or configured by the network for the beam measurement/reporting, activation and/or indication for the seamless mobility according to or following those specified/defined herein in the present disclosure, and/or one or more of the RS or RS resource sets (denoted by target RS or RS resource set(s))—determined or identified e.g. provided or configured by the network for the beam measurement/reporting, activation and/or indication for the seamless mobility according to or following those specified/defined herein in the present disclosure, e.g., their radio link qualities and/or L1 beam qualities such as L1-RSRPs/L1-SINRs, during the UE's movement through/across cells in the network. The UE could determine or identify the target RS(s) or RS resource(s), or the target RS or RS resource set(s) according to one or more of:
Fixed value(s)/rule(s) in system specification(s) and/or per RRC (re-)configuration: e.g., after the UE has received from the network the transition signaling(s) as defined/specified herein in the present disclosure—e.g., no earlier than M (M≥1) symbol(s)/slot(s) and/or no later than N (N≥1) symbol(s)/slot(s) after a last symbol/slot of receiving or reception of the transition signaling(s),
   In one example, for the case that the UE has determined or identified a set of RS(s) or RS resource(s) for beam measurement/reporting, activation and/or indication for seamless mobility according to or following those specified herein in the present disclosure, the UE could determine or identify the target RS(s) or RS resource(s) as or corresponding to the first (or last) R (R≥1) RS(s) or RS resource(s) and/or the RS(s) or RS resource(s) with the R lowest (or highest) RS/resource ID(s)/index(es) and/or the RS(s) or RS resource(s) with even (or odd) RS/resource ID(s)/index(s) and/or the RS(s) or RS resource(s) corresponding to the even (or odd) indexed entries in/of the set of RS(s) or RS resource(s).
   In another example, for the case the UE has determined or identified one or more sets of RS(s) or RS resource(s) for beam measurement/reporting, activation and/or indication for seamless mobility according to or following those specified herein in the present disclosure, the UE could determine or identify the target RS or RS resource set(s) as or corresponding to the first (or last) S (S≥1) RS or RS resource set(s) and/or the RS or RS resource set(s) with the S lowest (or highest) resource set ID(s)/index(es) and/or the RS or RS resource set(s) with even (or odd) resource set ID(s)/index(es) among all the RS or RS resource set(s)

The UE could determine or identify value(s) of M, N, R and/or S according or based on: (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be sent to the network via various UL channels/signals including CSI/beam report(s) and/or UE's capability signaling(s).
Network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. For instance, the UE could receive from the network, e.g., via/in/by a MAC CE subselection command and/or a DCI, one or more indicators to indicate the target RS(s) or RS resource(s), or the target RS or RS resource set(s), wherein the one or more indicators could be part of the aforementioned transition signaling(s), or the aforementioned transition signaling(s) could comprise or include or contain or provide or indicate the one or more indicators. When/if the signaling medium is DCI, the one or more indicators could be indicated or realized via/by a new/dedicated DCI field and/or repurposing one or more codepoints of one or more existing DCI fields in/of the corresponding DCI format(s). In particular, the one or more indicators could correspond to or could be in form of a bitmap:
   In one example, for the case that the UE has determined or identified a set of RS(s) or RS resource(s) for beam measurement/reporting, activation and/or indication for seamless mobility according to or following those specified herein in the present disclosure, the bitmap could have the same number of entries/bit positions as the number of RS(s) or RS resource(s) in the set; each entry/bit position of the bitmap could be corresponding/associated to a RS or RS resource—e.g. in form/terms of its RS/resource ID/index—in the set; when/if an entry/bit position of the bitmap is set to ‘1’ (or ‘0’), the RS or RS resource in the set corresponding/associated to the entry/bit position could correspond to or could be regarded as a target RS or RS resource for beam measurement/reporting, activation and/or indication for seamless mobility according to or following those specified herein in the present disclosure.
   In another example, for the case the UE has determined or identified one or more sets of RS(s) or RS resource(s) for beam measurement/reporting, activation and/or indication for seamless mobility according to or following those specified herein in the present disclosure, the bitmap could have the same number of entries/bit positions as the number of RS or RS resource set(s); each entry/bit position of the bitmap could be corresponding/associated to a RS or RS resource set—e.g. in form/terms of its resource set ID/index; when/if an entry/bit position of the bitmap is set to ‘1’ (or ‘0’), the RS or RS resource set (hence, the corresponding RS(s) or RS resource(s) e.g. in terms/form of the corresponding RS/resource ID(s)/index(es) therein) corresponding/associated to the entry/bit position could correspond to or could be regarded as a target RS or RS resource set for beam measurement/reporting, activation and/or indication for seamless mobility according to or following those specified herein in the present disclosure.
UE's implementation(s), or UE's autonomous determination or selection which could be further sent or indicated or transmitted to the network via various UL channels/signals including CSI/beam report(s) and/or UE's capability signaling(s).

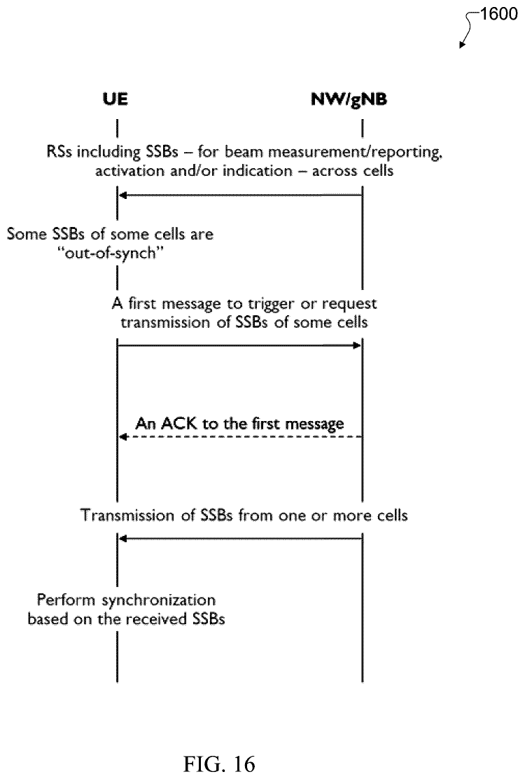

FIG. 16 illustrates an example procedure 1600 to support (early) synchronization for L1 seamless mobility according to embodiments of the present disclosure. The example procedure 1600 to support (early) synchronization for L1 seamless mobility shown in FIG. 16 is for illustration only and other embodiments can be used without departing from the scope of the present disclosure.

According to or following those specified/described herein in the present disclosure, to support or enable seamless mobility, a UE may need to keep monitoring, tracking, measuring and/or assessing one or more of the RSs or RS resources in the set—determined or identified e.g. provided or configured by the network for the beam measurement/reporting, activation and/or indication for the seamless mobility according to or following those specified/defined herein in the present disclosure, and/or one or more of the RS or RS resource sets—determined or identified e.g. provided or configured by the network for the beam measurement/reporting, activation and/or indication for the seamless mobility according to or following those specified/defined herein in the present disclosure, e.g., their radio link qualities and/or L1 beam qualities such as L1-RSRPs/L1-SINRs, during the UE's movement through/across cells in the network. The UE may not be able to monitor, track, measure or assess all of the RSs or RS resources, or all of the RS/RS resource sets, determined or identified e.g. provided or configured by the network for the beam measurement/reporting, activation and/or indication for the seamless mobility according to or following those specified/defined herein in the present disclosure, especially when the number of RS(s) or RS resource(s) in a set and/or the number of RS or RS resource set(s) as specified/defined herein in the present disclosure is relatively large. In this case,
The UE could indicate or transmit or send to the network, e.g., in part of their capability signaling(s), the maximum number of RS(s) or RS resource(s) in a set and/or the maximum number of RS or RS resource set(s) that they are capable of supporting for beam measurement/reporting, activation and/or indication for the seamless mobility, and/or
The UE could indicate or send or transmit to the network a first message to request the network to transmit one or more RSs and/or configure one or more RS resources—denoted by UE-initiated (UEI) RS(s) or RS resource(s)—and/or one or more RS or RS resource sets—denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s). The first message specified/defined herein could also comprise, include, contain, provide or indicate one or more aforementioned entity IDs to request the network to transmit the UEI RS(s) or RS resource(s) for the one or more entity IDs.
   The UE could expect to receive from the network a response no earlier than T1 (T1≥1) symbol(s)/slot(s) and/or no later than T2 (T2≥1) symbol(s)/slot(s) after a last symbol/slot of transmitting or transmission(s) of the first message. For example, the response could be in form of a one-bit ACK/NACK in response to the transmission(s) of the first message. For another example, the response could be to indicate (configuration) information related to the target RS(s) or RS resource(s), and/or the target RS or RS resource set(s) according to or following those specified herein in the present disclosure, and/or the UEI RS(s) or RS resource(s), and/or the UEI RS or RS resource set(s) according to or following those specified herein in the present disclosure; in this case, the response could optionally comprise or provide or indicate or contain or include one or more aforementioned entity IDs each corresponding/associated to a target RS/RS resource, a target RS/RS resource set, a UEI RS/RS resource and/or a UEI RS/RS resource set as specified/defined herein in the present disclosure whose (configuration) information may be indicated or comprised or included or contained or provided in (part of) the response; alternatively, the UE could determine or identify that the response is associated/specific/corresponding to one or more entity IDs as specified/defined herein in the present disclosure when/if the response is scrambled with the one or more entity IDs and/or the response is associated or specific or corresponding to one or more (configured, activated and/or indicated) TCI states associated, specific or corresponding to the one or more entity IDs. Furthermore, the response could be indicated or provided by the network in/via/by a MAC CE command and/or a DCI signaling, wherein when/if the signaling medium is DCI, the response could be indicated or realized via/by a new/dedicated DCI field and/or repurposing one or more codepoints of one or more existing DCI fields in/of the corresponding DCI format(s). Optionally, the response could be part of the aforementioned transition signaling(s), or the aforementioned transition signaling(s) could comprise or include or contain or provide or indicate the response.
   The UE could expect to receive from the network the one or more UEI RSs (and/or configuration(s) of the one or more UEI RS resources) and/or RSs (and/or configuration(s) of RS resources) in/of the one or more UEI RS or RS resource sets and start measuring, monitoring, assessing and/or tracking the one or more UEI RSs and/or RSs in/of the one or more UEI RS or RS resource sets, e.g., for obtaining their radio link qualities and/or beam qualities including L1-RSRPs/L1-SINRs and/or performing/conducing necessary synchronization, no earlier than T3 (T3≥1) symbol(s)/slot(s) and/or no later than T4 (T4≥1) symbol(s)/slot(s) after a last symbol/slot of transmitting or transmission(s) of the first message, and/or no earlier than T5 (T5≥1) symbol(s)/slot(s) and/or no later than T6 (T6≥1) symbol(s)/slot(s) after a last symbol/slot of receiving or reception(s) of the aforementioned network's response. The one or more UEI RSs and/or RSs in/of the one or more UEI RS or RS resource sets could be transmitted in part of the aforementioned transition signaling(s), or the aforementioned transition signaling(s) could also comprise or include or contain or provide or indicate or configure the one or more UEI RSs/RS resources and/or the one or more UEI RS/RS resource sets.

The UE could determine or identify value(s) of T1, T2, T3, T4, T5 and/or T6 according or based on: (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be sent to the network via various UL channels/signals including CSI/beam report(s) and/or UE's capability signaling(s). In FIG. 16, a conceptual example charactering the above described design procedure(s) is provided.

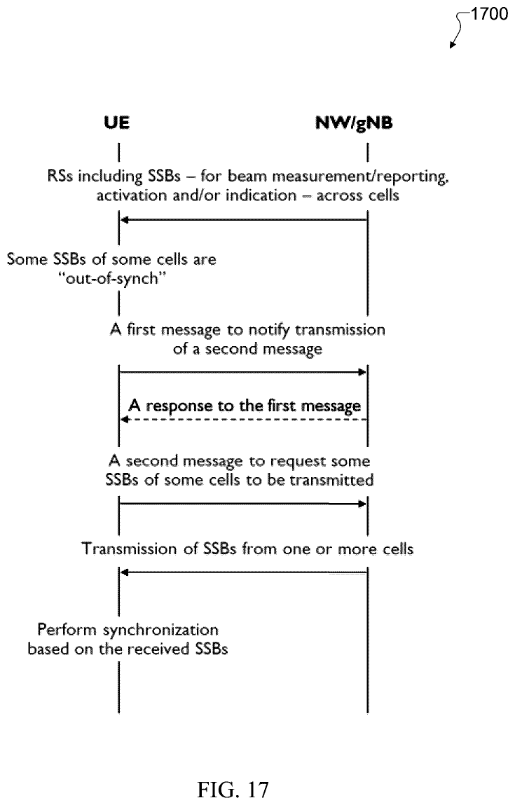

FIG. 17 illustrates another example procedure 1700 to support (early) synchronization for L1 seamless mobility according to embodiments of the present disclosure. The example procedure 1700 to support (early) synchronization for L1 seamless mobility shown in FIG. 17 is for illustration only and other embodiments can be used without departing from the scope of the present disclosure.

Optionally, the UE could indicate or send or transmit to the network a second message to notify the network:
for the case (case-i) that the UE has determined or identified a set of (target) RS(s) or RS resource(s) for beam measurement/reporting, activation and/or indication for seamless mobility according to or following those specified herein in the present disclosure, which one or more of the (target) RS(s) or RS resource(s)—denoted by requested RS(s) or RS resource(s)—in the set may need to be received, measured, assessed, synchronized, evaluated or monitored (again), which may need to be transmitted or sent from the network
for the case (case-ii) the UE has determined or identified one or more (target) sets of RS(s) or RS resource(s) for beam measurement/reporting, activation and/or indication for seamless mobility according to or following those specified herein in the present disclosure,
   which one or more of the (target) RS or RS resource set(s) denoted by requested RS or RS resource set(s)—hence the corresponding RS(s) or RS resource(s) e.g. in terms/form of the corresponding RS/resource ID(s)/index(es) therein—that may need to be received, measured, assessed, synchronized, evaluated or monitored (again), which may need to be transmitted or sent from the network; and/or
   which one or more of the RS(s) or RS resource(s)—denoted by requested RS(s) or RS resource(s)—in the aforementioned requested RS or RS resource set(s) that may need to be received, measured, assessed, synchronized, evaluated or monitored (again), which may need to be transmitted or sent from the network
for the case (case-iii) that the UE has determined or identified a list/pool of RS(s) or RS resource(s) higher layer configured/provided to the UE, which one or more of the RS(s) or RS resource(s)—denoted by requested RS(s) or RS resource(s)—in the list/pool that may need to be received, measured, assessed, synchronized, evaluated or monitored for beam measurement/reporting, activation and/or indication for seamless mobility, which may need to be transmitted or sent from the network
for the case (case-iv) the UE has determined or identified a list/pool of RS or RS resource set(s) higher layer configured/provided to the UE,
   which one or more of the RS or RS resource set(s) denoted by requested RS or RS resource set(s)—hence the corresponding RS(s) or RS resource(s) e.g. in terms/form of the corresponding RS/resource ID(s)/index(es) therein—in/from the list/pool that may need to be received, measured, assessed, synchronized, evaluated or monitored for beam measurement/reporting, activation and/or indication for seamless mobility, which may need to be transmitted or sent from the network; and/or
   which one or more of the RS(s) or RS resource(s)—denoted by requested RS(s) or RS resource(s)—in the aforementioned one or more of the RS or RS resource set(s) in/from the list/pool that may need to be received, measured, assessed, synchronized, evaluated or monitored for beam measurement/reporting, activation and/or indication for seamless mobility, which may need to be transmitted or sent from the network.

A conceptual example characterizing the above described design procedure(s) is presented in FIG. 17.

For the aforementioned case-i, the second message could comprise one or more of:
a bitmap having the same number of entries/bit positions as the number of (target) RS(s) or RS resource(s) in the set; each entry/bit position of the bitmap could be corresponding/associated to a (target) RS/RS resource e.g. in terms/form of its RS/resource ID/index in the set; in this case, when/if an entry/bit position in the bitmap is set to ‘1’ (or ‘0’), the (target) RS or RS resource in the set associated/corresponding to the entry/bit position could correspond to or could be regarded as a requested RS or RS resource as specified/defined herein in the present disclosure
one or more RS/resource IDs/indexes: in this case, the (target) RS(s) or RS resource(s) in the set associated/configured with the RS/resource ID(s)/index(es) having the same value(s) as that/those of the one or more RS/resource IDs/indexes could correspond to or could be regarded as requested RS(s) or RS resource(s) as specified/defined herein in the present disclosure.
one or more resource indicators comprising SSBRI(s) and/or CRI(s): in this case, the (target) RS(s) or RS resource(s) in the set associated/corresponding to the resource indicator(s) having the same value(s) as that/those of the one or more resource indicators could correspond to or could be regarded as requested RS(s) or RS resource(s) as specified/defined herein in the present disclosure, wherein bitwidth of the resource indicator(s) could be determined or identified as ┌log₂ K┐ and K≥1 here represents the total number of (target) RS(s) or RS resource(s) in the set.
one or more entity IDs as specified/defined herein in the present disclosure each associated/corresponding a reported RS/resource ID/index or a reported resource indicator (hence the corresponding (target) RS or RS resource in the set).

For the aforementioned case-ii, the second message could comprise one or more of:
a first bitmap having the same number of entries/bit positions as the number of (target) RS or RS resource set(s); each entry/bit position of the bitmap could be corresponding/associated to a (target) RS or RS resource set e.g. in terms/form of its resource set ID/index; in this case, when/if an entry/bit position in the first bitmap is set to ‘1’ (or ‘0’), the (target) RS or RS resource set associated/corresponding to the entry/bit position could correspond to or could be regarded as a requested RS or RS resource set as specified/defined herein in the present disclosure
one or more second bitmaps each corresponding/associated to a requested RS or RS resource set: a second bitmap could have the same number of entries/bit positions as the number of RS(s) or RS resource(s) in its corresponding/associated requested RS or RS resource set; each entry/bit position of the second bitmap could be corresponding/associated to a RS/RS resource e.g. in terms/form of its RS/resource ID/index in its corresponding/associated requested RS or RS resource set; in this case, when/if an entry/bit position in the second bitmap is set to ‘1’ (or ‘0’), the RS or RS resource in the requested RS or RS resource set associated/corresponding to the entry/bit position could correspond to or could be regarded as a requested RS or RS resource as specified/defined herein in the present disclosure; furthermore, the UE/network could determine or identify the correspondence/association between the one or more second bitmaps and the requested RS or RS resource set(s) according to or base on:
   fixed rule(s)/value(s) in system specification(s) and/or per RRC (re-)configuration: for instance, the first (or last) bitmap or the bitmap with the lowest (or highest) bitmap ID/index could be corresponding/associated to the first requested RS or RS resource set or the requested RS or RS resource set with the lowest resource set ID/index, the second (or second last) bitmap or the bitmap with the second lowest (or second highest) bitmap ID/index could be corresponding/associated to the second requested RS or RS resource set or the requested RS or RS resource set with the second lowest resource set ID/index, and so on, and the last (or first) bitmap or the bitmap with the highest (or lowest) bitmap ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more RS or RS resource set IDs/indexes: in this case, the (target) RS or RS resource set(s) associated/configured with the resource set ID(s)/index(es) having the same value(s) as that/those of the one or more RS or RS resource set IDs/indexes could correspond to or could be regarded as requested RS or RS resource set(s) as specified/defined herein in the present disclosure.
one or more resource set indicators comprising SSB resource set indicator(s) denoted by SSBRSI(s) and/or CSI resource set indicator(s) denoted by CRSI(s): in this case, the (target) RS or RS resource set(s) associated/corresponding to the resource set indicator(s) having the same value(s) as that/those of the one or more resource set indicators could correspond to or could be regarded as requested RS or RS resource set(s) as specified/defined herein in the present disclosure, wherein bitwidth of the resource set indicator(s) could be determined or identified as ┌log₂ L┐ and L≥1 here represents the total number of (target) RS or RS resource set(s)
one or more entity IDs as specified/defined herein in the present disclosure each associated/corresponding a reported RS or RS resource set ID/index or a reported resource set indicator (hence the corresponding (target) RS or RS resource set).
one or more groups of RS/resource IDs/indexes with each group corresponding/associated to a requested RS or RS resource set: in this case, for a requested RS or RS resource set, the RS(s) or RS resource(s) in the requested RS or RS resource set associated/configured with the RS/resource ID(s)/index(es) having the same value(s) as that/those of the RS/resource ID(s)/index(es) in the group corresponding/associated to the requested RS or RS resource set could correspond to or could be regarded as requested RS(s) or RS resource(s) as specified/defined herein in the present disclosure; furthermore, the UE/network could determine or identify the correspondence/association between the one or more groups of RS/resource IDs/indexes and the requested RS or RS resource set(s) according to or base on:
   fixed rule(s)/value(s) in system specification(s) and/or per RRC (re-)configuration: for instance, the first (or last) group of RS/resource ID(s)/index(es) or the group of RS/resource ID(s)/index(es) with the lowest (or highest) group ID/index could be corresponding/associated to the first requested RS or RS resource set or the requested RS or RS resource set with the lowest resource set ID/index, the second (or second last) group of RS/resource ID(s)/index(es) or the group of RS/resource ID(s)/index(es) with the second lowest (or second highest) group ID/index could be corresponding/associated to the second requested RS or RS resource set or the requested RS or RS resource set with the second lowest resource set ID/index, and so on, and the last (or first) group of RS/resource ID(s)/index(es) or the group of RS/resource ID(s)/index(es) with the highest (or lowest) group ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more groups of resource indicators comprising SSBRI(s) and/or CRI(s) with each group corresponding/associated to a requested RS or RS resource set: in this case, for a requested RS or RS resource set, the RS(s) or RS resource(s) in the requested RS or RS resource set associated/corresponding to the resource indicator(s) having the same value(s) as that/those of the resource indicator(s) in the group corresponding/associated to the requested RS or RS resource set could correspond to or could be regarded as requested RS(s) or RS resource(s) as specified/defined herein in the present disclosure; furthermore, the UE/network could determine or identify the correspondence/association between the one or more groups of resource indicators and the requested RS or RS resource set(s) according to or base on:
   fixed rule(s)/value(s) in system specification(s) and/or per RRC (re-)configuration: for instance, the first (or last) group of resource indicator(s) or the group of resource indicator(s) with the lowest (or highest) group ID/index could be corresponding/associated to the first requested RS or RS resource set or the requested RS or RS resource set with the lowest resource set ID/index, the second (or second last) group of resource indicator(s) or the group of resource indicator(s) with the second lowest (or second highest) group ID/index could be corresponding/associated to the second requested RS or RS resource set or the requested RS or RS resource set with the second lowest resource set ID/index, and so on, and the last (or first) group of resource indicator(s) or the group of resource indicator(s) with the highest (or lowest) group ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more entity IDs as specified/defined herein in the present disclosure each associated/corresponding a reported group of RS/resource IDs/indexes or a reported group of resource indicators (hence the corresponding requested RS or RS resource set).

For the aforementioned case-iii, the second message could comprise one or more of:
a bitmap having the same number of entries/bit positions as the number of RS(s) or RS resource(s) in the list/pool; each entry/bit position of the bitmap could be corresponding/associated to a RS/RS resource e.g. in terms/form of its RS/resource ID/index in the list/pool; in this case, when/if an entry/bit position in the bitmap is set to ‘1’ (or ‘0’), the RS or RS resource in the list/pool associated/corresponding to the entry/bit position could correspond to or could be regarded as a requested RS or RS resource as specified/defined herein in the present disclosure
one or more RS/resource IDs/indexes: in this case, the RS(s) or RS resource(s) in the list/pool associated/configured with the RS/resource ID(s)/index(es) having the same value(s) as that/those of the one or more RS/resource IDs/indexes could correspond to or could be regarded as requested RS(s) or RS resource(s) as specified/defined herein in the present disclosure.
one or more resource indicators comprising SSBRI(s) and/or CRI(s): in this case, the RS(s) or RS resource(s) in the list/pool associated/corresponding to the resource indicator(s) having the same value(s) as that/those of the one or more resource indicators could correspond to or could be regarded as requested RS(s) or RS resource(s) as specified/defined herein in the present disclosure, wherein bitwidth of the resource indicator(s) could be determined or identified as ┌log₂ K┐ and K≥1 here represents the total number of RS(s) or RS resource(s) in the list/pool.
one or more entity IDs as specified/defined herein in the present disclosure each associated/corresponding a reported RS/resource ID/index or a reported resource indicator (hence the corresponding RS or RS resource in the list/pool).

For the aforementioned case-iv, the second message could comprise one or more of:
a first bitmap having the same number of entries/bit positions as the number of RS or RS resource set(s) in the list/pool; each entry/bit position of the bitmap could be corresponding/associated to a RS or RS resource set e.g. in terms/form of its resource set ID/index in the list/pool; in this case, when/if an entry/bit position in the first bitmap is set to ‘1’ (or ‘0’), the RS or RS resource set in the list/pool associated/corresponding to the entry/bit position could correspond to or could be regarded as a requested RS or RS resource set as specified/defined herein in the present disclosure
one or more second bitmaps each corresponding/associated to a requested RS or RS resource set: a second bitmap could have the same number of entries/bit positions as the number of RS(s) or RS resource(s) in its corresponding/associated requested RS or RS resource set; each entry/bit position of the second bitmap could be corresponding/associated to a RS/RS resource e.g. in terms/form of its RS/resource ID/index in its corresponding/associated requested RS or RS resource set; in this case, when/if an entry/bit position in the second bitmap is set to ‘1’ (or ‘0’), the RS or RS resource in the requested RS or RS resource set associated/corresponding to the entry/bit position could correspond to or could be regarded as a requested RS or RS resource as specified/defined herein in the present disclosure; furthermore, the UE/network could determine or identify the correspondence/association between the one or more second bitmaps and the requested RS or RS resource set(s) according to or base on:
   fixed rule(s)/value(s) in system specification(s) and/or per RRC (re-)configuration: for instance, the first (or last) bitmap or the bitmap with the lowest (or highest) bitmap ID/index could be corresponding/associated to the first requested RS or RS resource set or the requested RS or RS resource set with the lowest resource set ID/index, the second (or second last) bitmap or the bitmap with the second lowest (or second highest) bitmap ID/index could be corresponding/associated to the second requested RS or RS resource set or the requested RS or RS resource set with the second lowest resource set ID/index, and so on, and the last (or first) bitmap or the bitmap with the highest (or lowest) bitmap ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more RS or RS resource set IDs/indexes: in this case, the RS or RS resource set(s) in the list/pool associated/configured with the resource set ID(s)/index(es) having the same value(s) as that/those of the one or more RS or RS resource set IDs/indexes could correspond to or could be regarded as requested RS or RS resource set(s) as specified/defined herein in the present disclosure
one or more resource set indicators comprising SSBRSI(s) and/or CRSI(s): in this case, the RS or RS resource set(s) in the list/pool associated/corresponding to the resource set indicator(s) having the same value(s) as that/those of the one or more resource set indicators could correspond to or could be regarded as requested RS or RS resource set(s) as specified/defined herein in the present disclosure, wherein bitwidth of the resource set indicator(s) could be determined or identified as ┌log₂ L┐ and L≥1 here represents the total number of RS or RS resource set(s) in the list/pool
one or more entity IDs as specified/defined herein in the present disclosure each associated/corresponding a reported RS or RS resource set ID/index or a reported resource set indicator (hence the corresponding RS or RS resource set in the list/pool).
one or more groups of RS/resource IDs/indexes with each group corresponding/associated to a requested RS or RS resource set: in this case, for a requested RS or RS resource set, the RS(s) or RS resource(s) in the requested RS or RS resource set associated/configured with the RS/resource ID(s)/index(es) having the same value(s) as that/those of the RS/resource ID(s)/index(es) in the group corresponding/associated to the requested RS or RS resource set could correspond to or could be regarded as requested RS(s) or RS resource(s) as specified/defined herein in the present disclosure; furthermore, the UE/network could determine or identify the correspondence/association between the one or more groups of RS/resource IDs/indexes and the requested RS or RS resource set(s) according to or base on:
   fixed rule(s)/value(s) in system specification(s) and/or per RRC (re-)configuration: for instance, the first (or last) group of RS/resource ID(s)/index(es) or the group of RS/resource ID(s)/index(es) with the lowest (or highest) group ID/index could be corresponding/associated to the first requested RS or RS resource set or the requested RS or RS resource set with the lowest resource set ID/index, the second (or second last) group of RS/resource ID(s)/index(es) or the group of RS/resource ID(s)/index(es) with the second lowest (or second highest) group ID/index could be corresponding/associated to the second requested RS or RS resource set or the requested RS or RS resource set with the second lowest resource set ID/index, and so on, and the last (or first) group of RS/resource ID(s)/index(es) or the group of RS/resource ID(s)/index(es) with the highest (or lowest) group ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more groups of resource indicators comprising SSBRI(s) and/or CRI(s) with each group corresponding/associated to a requested RS or RS resource set: in this case, for a requested RS or RS resource set, the RS(s) or RS resource(s) in the requested RS or RS resource set associated/corresponding to the resource indicator(s) having the same value(s) as that/those of the resource indicator(s) in the group corresponding/associated to the requested RS or RS resource set could correspond to or could be regarded as requested RS(s) or RS resource(s) as specified/defined herein in the present disclosure; furthermore, the UE/network could determine or identify the correspondence/association between the one or more groups of resource indicators and the requested RS or RS resource set(s) according to or base on:
   fixed rule(s)/value(s) in system specification(s) and/or per RRC (re-)configuration: for instance, the first (or last) group of resource indicator(s) or the group of resource indicator(s) with the lowest (or highest) group ID/index could be corresponding/associated to the first requested RS or RS resource set or the requested RS or RS resource set with the lowest resource set ID/index, the second (or second last) group of resource indicator(s) or the group of resource indicator(s) with the second lowest (or second highest) group ID/index could be corresponding/associated to the second requested RS or RS resource set or the requested RS or RS resource set with the second lowest resource set ID/index, and so on, and the last (or first) group of resource indicator(s) or the group of resource indicator(s) with the highest (or lowest) group ID/index could be corresponding/associated to the last requested RS or RS resource set or the requested RS or RS resource set with the highest resource set ID/index
   network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   UE's implementation(s), or UE's autonomous determination or selection which could be further sent or indicated or transmitted to the network via various UL channels/signals e.g. CSI/beam report(s) and/or UE's capability signaling(s) and/or in part of the second message.
one or more entity IDs as specified/defined herein in the present disclosure each associated/corresponding a reported group of RS/resource IDs/indexes or a reported group of resource indicators (hence the corresponding requested RS or RS resource set).

In one embodiment, the UE could report, transmit or send to the network, e.g., in a reporting instance/CSI or beam report, one or more first indicators (e.g., in part of the second message) to indicate whether the RS or RS resource associated/corresponding to a reported resource indicator (or a reported RS/resource ID/index) in the reporting instance/CSI or beam report is synchronized or not; for instance, the one or more first indicators could be in form of a bitmap having the same number of entries/bit positions as the number of the reported resource indicators (or the reported RS/resource IDs/indexes) in the reporting instance/CSI or beam report; each entry/bit position of the bitmap could be associated/corresponding to a reported resource indicator (or a reported RS/resource ID/index) in the reporting instance/CSI or beam report; in this case,
when/if an entry/bit position of the bitmap is set to ‘1’ (or ‘0’), the RS or RS resource associated/corresponding to the reported resource indicator (or the reported RS/resource ID/index) associated/corresponding to the entry/bit position in the reporting instance/CSI or beam report is regarded as synchronized—denoted by a synchronized RS or RS resource
otherwise, e.g., when/if an entry/bit position of the bitmap is set to ‘0’ (or ‘1’), the RS or RS resource associated/corresponding to the reported resource indicator (or the reported RS/resource ID/index) associated/corresponding to the entry/bit position in the reporting instance/CSI or beam report is regarded as unsynchronized—denoted by an unsynchronized RS or RS resource.

Optionally, the UE could report, transmit or send to the network, e.g., in a reporting instance/CSI or beam report, one or more second indicators (e.g., in part of the second message) to indicate whether the RS or RS resource set (hence, the corresponding RS(s) or RS resource(s) therein) associated/corresponding to a reported resource set indicator (or a reported resource set ID/index) in the reporting instance/CSI or beam report is synchronized or not; for instance, the one or more second indicators could be in form of a bitmap having the same number of entries/bit positions as the number of the reported resource set indicators (or the reported RS/resource IDs/indexes) in the reporting instance/CSI or beam report; each entry/bit position of the bitmap could be associated/corresponding to a reported resource set indicator (or a reported resource set ID/index) in the reporting instance/CSI or beam report; in this case,
when/if an entry/bit position of the bitmap is set to ‘1’ (or ‘0’), the RS or RS resource set (hence the corresponding RS(s) or RS resource(s) therein) associated/corresponding to the reported resource set indicator (or the reported resource set ID/index) associated/corresponding to the entry/bit position in the reporting instance/CSI or beam report is regarded as synchronized—denoted by a synchronized RS or RS resource set
otherwise, e.g., when/if an entry/bit position of the bitmap is set to ‘0’ (or ‘1’), the RS or RS resource set (hence the corresponding RS(s) or RS resource(s) therein) associated/corresponding to the reported resource set indicator (or the reported resource set ID/index) associated/corresponding to the entry/bit position in the reporting instance/CSI or beam report is regarded as unsynchronized—denoted by an unsynchronized RS or RS resource set.

After transmitting or sending to the network the second message, the UE could expect to receive from the network a response no earlier than Q1 (Q1≥1) symbol(s)/slot(s) and/or no later than Q2 (Q2≥1) symbol(s)/slot(s) after a last symbol/slot of transmitting or transmission(s) of the second message. For example, the response could be in form of a one-bit ACK/NACK in response to the transmission(s) of the second message. For another example, the response could be transmission(s) of one or more RSs; the transmitted one or more RSs here could correspond to (e.g., having the same value(s) of RS/resource ID(s)/index(es)) one or more of:
for the case that the UE has determined or identified a set of (target) RS(s) or RS resource(s) for beam measurement/reporting, activation and/or indication for seamless mobility according to or following those specified herein in the present disclosure, one or more of the (target) RSs in the set
for the case that the UE has determined or identified a list/pool of RS(s) or RS resource(s) higher layer configured/provided to the UE, one or more of the RSs in the list/pool
for the case that the UE has determined or identified one or more (target) sets of RS(s) or RS resource(s) for beam measurement/reporting, activation and/or indication for seamless mobility according to or following those specified herein in the present disclosure, one or more RSs in/from/of one or more of the (target) sets
for the case that the UE has determined or identified a list/pool of one or more sets of RS(s) or RS resource(s) higher layer configured/provided to the UE, one or more RSs in/from/of one or more of the sets in the list/pool
one or more of the target RSs, and/or one or more RSs in/from/of one or more of the target RS/RS resource sets
one or more of the synchronized RSs, and/or one or more RSs in/from/of one or more of the synchronized RS/RS resource sets
one or more of the requested RSs, and/or one or more RSs in/from/of one or more of the requested RS/RS resource sets

Here, the one or more transmitted RSs could also be regarded as UEI RS(s) and/or RS(s) in/from/of UEI RS or RS resource set(s). In this case, the response could optionally comprise or provide or indicate or contain or include one or more entity IDs as specified/defined herein in the present disclosure each corresponding/associated to a transmitted RS; alternatively, the UE could determine or identify that the response is associated/specific/corresponding to one or more entity IDs as specified/defined herein in the present disclosure when/if the response is scrambled with the one or more entity IDs and/or the response is associated or specific or corresponding to one or more (configured, activated and/or indicated) TCI states associated, specific or corresponding to the one or more entity IDs. Furthermore, the response could be indicated or provided by the network in/via/by a MAC CE command and/or a DCI signaling, wherein when/if the signaling medium is DCI, the response could be indicated or realized via/by a new/dedicated DCI field and/or repurposing one or more codepoints of one or more existing DCI fields in/of the corresponding DCI format(s). Optionally, the response could be part of the aforementioned transition signaling(s), or the aforementioned transition signaling(s) could comprise or include or contain or provide or indicate the response. Additionally, according to or following those specified/defined herein in the present disclosure,
when/if a UE reports, transmits or sends to the network, e.g. in a reporting instance/CSI or beam report, a resource indicator such as a SSBRI or a CRI (e.g., in part of the second message), the UE could determine or identify the bitwidth of the resource indicator as ┌log₂ U┐ with U≥1, and/or the value(s) of U according to or based on one or more of:
   for the case that the UE has determined or identified a set of (target) RS(s) or RS resource(s) for beam measurement/reporting, activation and/or indication for seamless mobility according to or following those specified herein in the present disclosure, U represents the total number of the (target) RSs in the set
   for the case that the UE has determined or identified a list/pool of RS(s) or RS resource(s) higher layer configured or provided to the UE, U represents the total number of the RSs in the list/pool
   for the case that the UE has determined or identified one or more (target) sets of RS(s) or RS resource(s) for beam measurement/reporting, activation and/or indication for seamless mobility according to or following those specified herein in the present disclosure, U represents the total number of the RSs in/from/of the (target) sets
   for the case that the UE has determined or identified a list/pool of one or more sets of RS(s) or RS resource(s) higher layer configured or provided to the UE, U represents the total number of the RSs in/from/of the sets in the list/pool
   U represents the total number of the target RSs, and/or the total number of the RSs in/from/of the target RS/RS resource sets, as specified/defined herein in the present disclosure
   U represents the total number of the requested RSs, and/or the total number of the RSs in/from/of the requested RS/RS resource sets, as specified/defined herein in the present disclosure
   U represents the total number of the synchronized RSs, and/or the total number of the RSs in/from/of the synchronized RS/RS resource sets, as specified/defined herein in the present disclosure
   U represents the total number of the transmitted RSs as specified/defined herein in the present disclosure
when/if a UE reports, transmits or sends to the network, e.g. in a reporting instance/CSI or beam report, a resource set indicator such as a SSBRSI or a CRSI (e.g., in part of the second message), the UE could determine or identify the bitwidth of the resource set indicator as ┌log₂ V┐ with V≥1, and/or the value(s) of V according to or based on one or more of:
   for the case that the UE has determined or identified one or more (target) sets of RS(s) or RS resource(s) for beam measurement/reporting, activation and/or indication for seamless mobility according to or following those specified herein in the present disclosure, V represents the total number of the (target) sets
   for the case that the UE has determined or identified a list/pool of one or more sets of RS(s) or RS resource(s) higher layer configured or provided to the UE, V represents the total number of the RS or RS resource sets in the list/pool
   V represents the total number of the target RS/RS resource sets, as specified/defined herein in the present disclosure
   V represents the total number of the requested RS/RS resource sets, as specified/defined herein in the present disclosure
   V represents the total number of the synchronized RS/RS resource sets, as specified/defined herein in the present disclosure
   V represents the total number of the RS or RS resource sets that comprise the transmitted RSs as specified/defined herein in the present disclosure

The UE could determine or identify value(s) of Q1 and/or Q2 according or based on: (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be sent to the network via various UL channels/signals including CSI/beam report(s) and/or UE's capability signaling(s).

In one operation mode (Mode A),
Step-1: the UE could send the first message, e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. According to those specified/defined herein in the present disclosure, the first message could request the network to transmit one or more RSs and/or configure one or more RS resources—denoted by UE-initiated (UEI) RS(s) or RS resource(s)—and/or one or more RS or RS resource sets—denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s), and/or request UL resource allocation and/or indication for transmitting second message(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by firstMessage-Config comprising one or more of:
   firstMessageId: used to modify a first message configuration and to indicate, in LogicalChannelConfig, the first message configuration to which a logical channel is mapped and to indicate the first message configuration for which a first message (i.e., the first PUCCH resource) is used
   fm-ProhibitTimer: a timer for first message transmission(s) on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: after the UE has transmitted the first message, the UE could expect to receive from the network a (downlink/uplink) DCI in response to the first message, within a time window (e.g., no earlier than A1 symbol(s)/slot(s) and/or no later than A2 symbol(s)/slot(s)) starting from the first or last symbol/slot/etc. of the transmission of the first message. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.), A1 and/or A2. In addition, the UE could indicate to the network, e.g., in form of a UE's capability via a UE's capability signaling, whether or not the UE could expect to receive from the network the (downlink/uplink) DCI in response to the first message transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the first message. The (downlink/uplink) DCI in response to the first message could comprise one or more of the following components:
   Component-1: a one-bit indicator with ‘1’ (or ‘0’) indicating acknowledgement (ACK) for the first message and ‘0’ (or ‘i’) indicating non-ACK (NACK) for the first message
   Component-2: a time gap/duration (e.g., in number of symbols/slots/etc.)
   Component-3: a priority order or value for the first message and/or second message(s) associated/specific to the first message as defined/specified herein in the present disclosure
   Component-4: a time offset (e.g., in number of symbols/slots/etc.)
   Component-5: resource allocation and/or indication for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the second message(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the second message(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the second message(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the second message(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the second message(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH). In this step, the UE could expect to receive the (downlink/uplink) DCI in response to the transmission of the first message comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission could indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel.

The (downlink/uplink) DCI (in Step-2) in response to the transmission of the first message in Step-1 could be in various DCI formats including (uplink) DCI format(s) including DCI format(s) 0_0, 0_1, 0_2 and/or 0_3, (downlink) DCI format(s) including DCI format(s) 10, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the first message transmission in Step-1 via/in the first UL channel:
The group common DCI format could comprise or indicate or provide one or more sets of components (e.g., one or more of Component-1—Component-7 as defined/specified herein in the present disclosure) with each set of components dedicated or specific or associated or corresponding to a first message or a transmission of a first message or a configuration of first message or an order/index of a (transmission of) first message, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a first message in Step-1; upon detection or reception of the group common DCI in Step-2, the UE could identify or determine the set of components (e.g., one or more of Component-1—Component-7 as defined or specified herein in the present disclosure) provided/indicated in the group common DCI format that are associated or specific or dedicated to the first message in Step-1 and/or any other identification information related to the UE. The UE could then identify or determine the resource(s) based on the identified or determined set of components following those specified herein in the present disclosure to use for transmitting or sending the second UL channel carrying or conveying the second message(s) associated/specific to the first message transmitted or sent in Step-1 via/in the first UL channel.

In one operation mode (Mode B),
Step-1: the UE could send the first message, e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. Here, the first message could request the network to transmit one or more RSs and/or configure one or more RS resources—denoted by UE-initiated (UEI) RS(s) or RS resource(s)—and/or one or more RS or RS resource sets—denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s), and/or indicate a potential transmission of the second message(s) associated/specific to the first message, and/or request UL resource allocation and/or indication for a second UL channel that could carry or convey the second message(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by FM-Config comprising one or more of:
   firstMessageId: used to modify a first message configuration and to indicate, in LogicalChannelConfig, the first message configuration to which a logical channel is mapped and to indicate the first message configuration for which a first message resource (i.e., the first PUCCH resource) is used
   fm-ProhibitTimer: a timer for first message transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2); the UE could determine or identify the resource(s) for the second UL channel according to one or more of:
   In one example, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than B1 symbol(s)/slot(s) and/or no later than B2 symbol(s)/slot(s)) after the first or last symbol/slot/etc. of the transmission of the first message. The value(s) of the time period/window/duration t1, B1 and/or B2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, B1 and/or B2 (e.g., in form/terms/number of slots/symbols/etc.): for example, the value(s) of t1, B1 and/or B2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, B2 and/or B1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel, regardless of whether or not a (downlink/uplink) DCI format in response to the first message is received, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than B1 symbol(s)/slot(s) and/or no later than B2 symbol(s)/slot(s)) after the first or last symbol/slot/etc. of the transmission of the first message. The value(s) of the time period/window/duration t1, B1 and/or B2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, B1 and/or B2 (e.g., in form/terms/number of slots/symbols/etc.): for example, the value(s) of t1, B1 and/or B2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, B1 and/or B2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C),
Step-1: the UE could send the first message, e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. Here, the first message could request the network to transmit one or more RSs and/or configure one or more RS resources—denoted by UE-initiated (UEI) RS(s) or RS resource(s)—and/or one or more RS or RS resource sets—denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s), and/or indicate a potential transmission of the second message(s) associated/specific to the first message, and/or request UL resource allocation and/or indication for a second UL channel that could carry or convey the second message(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by FM-Config comprising one or more of:
   firstMessageId: used to modify a first message configuration and to indicate, in LogicalChannelConfig, the first message configuration to which a logical channel is mapped and to indicate the first message configuration for which a first message resource (i.e., the first PUCCH resource) is used
   fm-ProhibitTimer: a timer for first message transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: after the UE has transmitted the first message, the UE could expect to receive from the network a (downlink/uplink) DCI in response to the first message, within a time window (or no earlier than C1 symbol(s)/slot(s) and/or no later than C2 symbol(s)/slot(s)) starting from the first or last symbol/slot/etc. of the transmission of the first message. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window, C1 and/or C2. In addition, the UE could indicate to the network, e.g., in form of a UE's capability via a UE's capability signaling, whether or not the UE could expect to receive from the network the (downlink/uplink) DCI in response to the first message transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the first message. The (downlink/uplink) DCI in response to the first message could comprise one or more of the following components:
   Component-1: a one-bit indicator with ‘1’ (or ‘0’) indicating acknowledgement (ACK) for the first message and ‘0’ (or ‘1’) indicating non-ACK (NACK) for the first message
   Component-2: a time gap/duration (e.g., in number of symbols/slots/etc.)
   Component-3: a priority order or value for the first message and/or the second message(s) associated/specific to the first message as defined/specified herein in the present disclosure
   Component-4: a time offset (e.g., in number of symbols/slots/etc.)
   Component-5: resource allocation and/or indication for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the second message(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the second message(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂ K┘ or k=┌log₂ K┐. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the second message(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the second message(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the second message(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the first message in Step-1, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D1 and/or D2 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the first message in Step-1, and/or when/if after the UE has transmitted or sent the first message via the first UL channel in Step-1 but does not receive the (downlink/uplink) DCI in response to the first message as specified or discussed in Step-2 a first time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, and/or when/if after the UE has transmitted or sent the (same) first message max_FM times/instances—each separated by a time gap—within a second time period/window/duration (e.g., denoted by t2 in terms/form/number of symbols/slots/etc., or no earlier than E1 symbol(s)/slot(s) and/or no later than E2 symbol(s)/slot(s)) but does not receive the (downlink/uplink) DCI in response to the last transmission time/instance of the (same) first message, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a third time period/window/duration (e.g., denoted by t3 in terms/form/number of symbols/slots/etc., or no earlier than F1 symbol(s)/slot(s) and/or no later than F2 symbol(s)/slot(s)) after the first or last symbol/slot/etc. of the transmission of the first message. The value(s) of the max_FM, the time gap, the first, second and/or third time period(s)/window(s)/duration(s) t1, t2 and/or t3, D1, D2, E1, E2, F1 and/or F2 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.), D1, D2, E1, E2, F1 and/or F2: for example, the value(s) of t1, t2 and/or t3, D1, D2, E1, E2, F1 and/or F2 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3, D1, D2, E1, E2, F1 and/or F2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the first message comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the first message comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the first message comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the first message comprising one or more of the components including Component-1 (e.g., an ACK for the first message), Component-2, Component-3 and/or Component-4 and/or Component-7 (i.e., except Component-5 and Component-6). For this design example, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t2 in terms/form/number of symbols/slots/etc., or no earlier than E1 symbol(s)/slot(s) and/or no later than E2 symbol(s)/slot(s)) after the first or last symbol/slot/etc. of the transmission of the first message and/or after the first or last symbol/slot/etc. of the reception of the (downlink/uplink) DCI format in response to the transmission of the first message. The value(s) of the time period/window/duration t2, E1 and/or E2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2, E1 and/or E2 could be determined according to the time gap/duration provided/indicated in Component-2 and/or the time offset provided/indicated in Component-4 as/in part of the (downlink/uplink) DCI format in response to the first message; for (iii), i.e., for the UE to autonomously determine or select the value(s) of the time period/window/duration t2, E1 and/or E2 (e.g., in form/terms/number of slots/symbols/etc.): for example, the value(s) of t2, E1 and/or E2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2, E1 and/or E2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission does not indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission could indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, when/if the (downlink/uplink) DCI in response to the first message is received p1 (in number of slots/symbols/etc.) earlier in time than the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the second message(s) associated/specific to the first message sent/transmitted in/via the first UL channel (in Step-1) on or over the determined or identified resource(s) for the second UL channel. The value(s) of p1, p2, t1 and/or the time period/window/duration, D1 and/or D2 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, when/if the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message is ql (in number of slots/symbols/etc.) earlier in time than the reception of the (downlink/uplink) DCI in response to the first message, and/or when/if the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D2 and/or D1 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, regardless of how/when the periodic/semi-persistent PUCCH resource(s) and/or the PUSCH resource(s) such as CG PUSCH of Type1 and/or Type2 is (pre-)configured by the network for transmitting or sending the second message(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the second message(s) associated/specific to the first message sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel, regardless of whether or not a (downlink/uplink) DCI format in response to the first message is received, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D1 and/or D2 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel and/or the UE receives a (downlink/uplink) DCI in response to the first message comprising at least an ACK (e.g., in Component-1) for the transmission of the first message, regardless of whether or not the (downlink/uplink) DCI format in response to the first message comprises or provides or indicates component(s)—e.g., Component-5 and/or Component-6 as defined/specified herein in the present disclosure—that provides or comprises or indicates resource allocation and/or indication for the second UL channel to carry or convey the second message(s) associated/specific to the first message, the UE could transmit or send to the network—via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message and/or after the first or last symbol/slot/etc. of the reception of the (downlink/uplink) DCI format in response to the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D2 and/or D1 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the first message in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the first message transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a first message or a transmission of a first message or a configuration of first message or an order/index of a (transmission of) first message, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a first message in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the first message in Step-1 and/or any other identification information related to the UE. The UE could then identify or determine the resource(s) based on the identified or determined set of components following those specified herein in the present disclosure to use for transmitting or sending the second UL channel carrying or conveying the second message(s) associated/specific to the first message transmitted or sent in Step-1 via/in the first UL channel.

Supporting Mode A (and/or Mode B and/or Mode C) and therefore the corresponding operations could be a basic UE feature such that when/if a UE supports the seamless mobility (or for a UE supporting (early) synchronization for the seamless mobility), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the seamless mobility and/or (early) synchronization for the seamless mobility; in this case, the UE could indicate to the network in their capability signaling(s) one or more of.
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

In one embodiment, a UE could transmit or send to the network, in a two-part UCI (e.g., in a single reporting instance/CSI or beam report), the first and second messages specified/defined herein in the present disclosure. For instance, the UE could transmit or send to the network, in part 1 of the two-part UCI, the first message; in this case, part 1 of the two-part UCI could also comprise or include or contain or provide an indicator to indicate presence or absence of part 2 of the two-part UCI. Alternatively, when/if the first message is to request the network to transmit one or more RSs and/or configure one or more RS resources—denoted by UE-initiated (UEI) RS(s) or RS resource(s)—and/or one or more RS or RS resource sets—denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s), part 2 of the two-part UCI could be absent, and/or when/if the first message is to indicate a potential transmission of the second message(s) associated/specific to the first message, and/or request UL resource allocation for carrying or conveying the second message(s), part 2 of the two-part UCI could be present.

According to or following those specified/defined herein in the present disclosure, for Mode A, Mode B and/or Mode C, a UE could transmit or send, over/in/by/via one or more (DG or CG) PUSCH resources of the second UL channel, a second message as specified/defined herein in the present disclosure. Here, the UE could transmit or send to the network, in a two-part UCI (e.g., in a single reporting instance/CSI or beam report), the second message. For instance, part 1 of the two-part UCI could comprise, include, contain or provide indicator(s) to indicate presence or absence of part 2 of the two-part UCI, and/or information related to payload size of part 2 of the two-part UCI—e.g., the information could comprise the number of requested RS(s) or RS resource(s) reported in part 2 of the two-part UCI, the number of requested RS or RS resource set(s) reported in part 2 of the two-part UCI, as specified/defined herein in the present disclosure. In this case, part 2 of the two-part UCI could comprise, include, contain or provide information related to the requested RS(s) or RS resource(s)—e.g., the corresponding RS/resource ID(s)/index(es) and/or resource indicator(s) and/or bitmap(s) as specified/defined herein in the present disclosure, information related to the requested RS or RS resource set(s)—e.g., the corresponding resource set ID(s)/index(es) and/or resource set indicator(s) and/or bitmap(s) as specified/defined herein in the present disclosure, information related to synchronization/unsynchronization status of one or more RSs/RS resources and/or RS/RS resource sets associated/corresponding to the reported RS/resource IDs/indexes and/or resource indicators and/or resource set IDs/indexes and/or resource set indicators—e.g., indicated via one or more bitmaps as specified/defined herein in the present disclosure, and/or etc. Furthermore, part 2 of the two-part UCI could be absent when/if one or more of the following conditions are achieved, held or satisfied:
the total number of requested RS(s) or RS resource(s) is less than or equal to a threshold
the total number of requested RS or RS resource set(s) is less than or equal to a threshold
the number of requested RS(s) or RS resource(s) in each of the requested RS or RS resource set(s) is less than or equal to a threshold,
   wherein the UE could determine or identify value(s) of the aforementioned threshold(s) according to or based on: (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be sent to the network via various UL channels/signals including CSI/beam report(s) and/or UE's capability signaling(s).

According to or following those specified/defined herein in the present disclosure, the UE could transmit or send or indicate to the network, a/the first message and/or a/the second message, no earlier than Z1 symbol(s)/slot(s) and/or no later than Z2 symbol(s)/slot(s) starting from or after a last (or first) symbol or slot of receiving or reception of transition signaling(s) as specified/defined herein in the present disclosure. Furthermore, (higher layer(s) of) the UE could start a prohibit timer (information related to the prohibit timer e.g. its duration or length could be higher layer configured or provided to the UE)
after or starting from a last (or first) symbol/slot/etc. of transmitting or transmission of a first message, and/or
after or starting from a last (or first) symbol/slot/etc. of transmitting or transmission of a second message, and/or
after or starting from a last (or first) symbol/slot/etc. of receiving or reception of an aforementioned network's response to the transmission of a first message, and/or
after or starting from a last (or first) symbol/slot/etc. of receiving or reception of an aforementioned network's response to the transmission of a second message, and/or
after or starting from a last (or first) symbol/slot/etc. of receiving or reception of one or more transmitted RSs from the network according to or following those specified herein in the present disclosure, and/or
after or starting from a last (or first) symbol/slot/etc. of receiving or reception of a (unified) TCI state(s) activation/deactivation MAC CE command indicating at least one TCI state (e.g., via a TCI codepoint indicated therein) associated to a RS or RS resource, e.g., a target RS/RS resource or a requested RS/RS resource or a synchronized RS/RS resource, specified/defined herein in the present disclosure, and/or
after or starting from a last (or first) symbol/slot/etc. of when a (unified) TCI state(s) activation/deactivation MAC CE command indicating at least one TCI state (e.g., via a TCI codepoint indicated therein) associated to a RS or RS resource, e.g., a target RS/RS resource or a requested RS/RS resource or a synchronized RS/RS resource, specified/defined herein in the present disclosure becomes applicable, and/or
G≥1 symbol(s)/slot(s)/etc. after or starting from a last (or first) symbol/slot/etc. of receiving or reception of transition signaling(s) as specified/defined herein in the present disclosure;
   when the prohibit timer is running, the UE may not or is not allowed or is not expected to transmit, send or indicate to the network any first or second message(s).

Throughout the present disclosure, a message is equivalent to a notification, an indication/indicator, a transmission/transmission occasion, a report and/or etc. Furthermore, for Mode A, Mode B and/or Mode C, a PUCCH resource of the first UL channel could be associated, mapped or linked to a PUSCH resource of the second UL channel, and a PUSCH resource of the second UL channel could be associated, mapped or linked to a PUCCH resource of the first UL channel—i.e., one-to-one association, mapping or linkage; in this case, the UE could determine or identify the one-to-one association(s), mapping(s) or linkage(s) according to or based on: (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be sent to the network via various UL channels/signals including CSI/beam report(s) and/or UE's capability signaling(s).

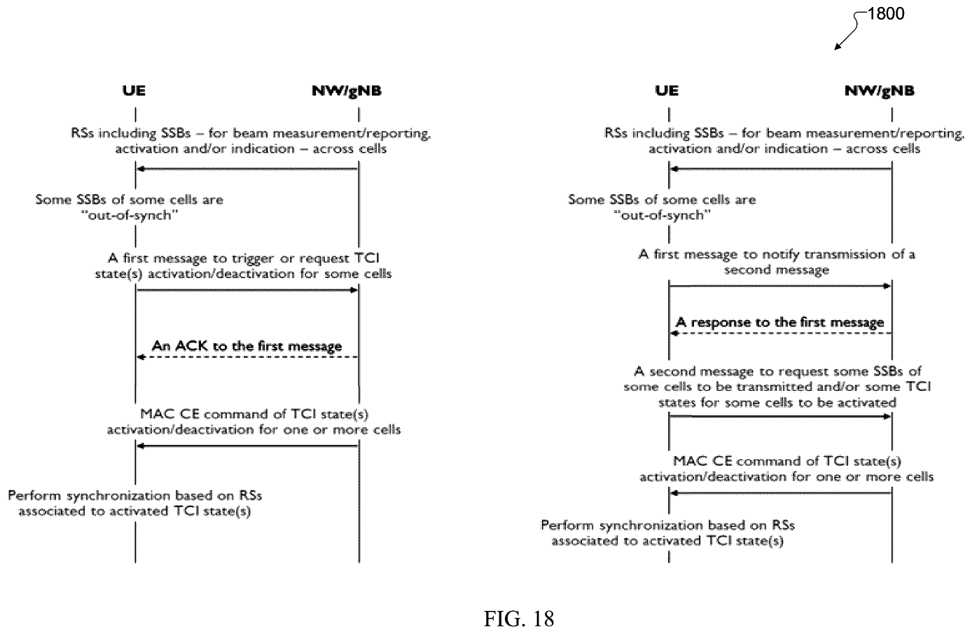

FIG. 18 illustrates yet another example procedure 1800 to support UE-initiated (early) synchronization for L1 seamless mobility according to embodiments of the present disclosure. The example procedure 1800 to support UE-initiated (early) synchronization for L1 seamless mobility shown in FIG. 18 is for illustration only and other embodiments can be used without departing from the scope of the present disclosure.

Throughout the present disclosure, (i) any configuration(s), activation(s) and/or indication(s) of a RS or RS resource (e.g., in a RS or RS resource set) could correspond to or could be equivalent to or could be replaced by/with or could be used in an exchangeable manner with configuration(s), activation(s) and/or indication(s) of a TCI state associated/specific/corresponding to the RS or RS resource (e.g., in a RS or RS resource set) according to or following those specified herein in the present disclosure; in this case, a RS/resource ID/index and/or a resource indicator (when/if reported) could correspond to or could be equivalent to or could be replaced by/with or could be used in an exchangeable manner with a TCI state ID/index associated to/configured or provided for the TCI state; furthermore, any configuration(s), activation(s) and/or indication(s) of a RS or RS resource set (comprising one or more RSs or RS resources e.g. in terms/form of their RS/resource IDs/indexes) could correspond to or could be equivalent to or could be replaced by/with or could be used in an exchangeable manner with configuration(s), activation(s) and/or indication(s) of one or more TCI states each associated/specific/corresponding to a RS or RS resource in the RS or RS resource set according to or following those specified herein in the present disclosure; in this case, a RS or RS resource set ID/index and/or a resource set indicator (when/if reported) could correspond to or could be equivalent to or could be replaced by/with or could be used in an exchangeable manner with one or more TCI state IDs/indexes associated to/configured or provided for the one or more TCI states, and (ii) transmission(s)/reception(s) of a RS (e.g., in a RS or RS resource set) including a SSB or a CSI-RS could correspond to or could be equivalent to or could be replaced by/with or could be used in an exchangeable manner with indication(s) of a TCI state (e.g., via a codepoint of a (unified) TCI state(s) activation/activation MAC CE command and/or a TCI codepoint of a TCI field in a beam indication DCI of DCI format 1_1/1_2 with or without DL assignment) associated/specific/corresponding to the RS (e.g., in the RS or RS resource set) according to or following those specified herein in the present disclosure, and/or transmission(s)/reception(s) of a (unified) TCI state(s) activation/deactivation MAC CE command indicating at least one TCI state (e.g., via a TCI codepoint indicated therein) associated/specific/corresponding to the RS (e.g., in the RS or RS resource set) according to or following those specified herein in the present disclosure. Optionally, a network's response to the first and/or second message(s) as specified/defined herein in the present disclosure could correspond to or comprise or could be inform of a (unified) TCI state(s) activation/deactivation MAC CE command indicating at least one TCI state (e.g., via a TCI codepoint indicated therein) associated to a RS or RS resource, e.g., a target RS/RS resource or a requested RS/RS resource or a synchronized RS/RS resource, specified/defined herein in the present disclosure. Throughout the present disclosure, a TCI state associated, specific or corresponding to a RS or RS resource (or vice versa) could correspond to or could be equivalent to or could be referred to/regarded as:
the RS or RS resource could correspond to a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in the TCI state.

In FIG. 18, conceptual examples of (early) synchronization for seamless mobility similar to those presented in FIG. 15 and/or FIG. 17 are presented. Different from those presented in FIG. 15 and/or FIG. 16 wherein the (beam-level early) synchronization for seamless mobility is realized via (UE and/or network sides') signaling(s)—e.g., configuration(s), activation(s), indication(s) and/or transmission(s)/reception(s)—of one or more RSs or RS resources, the (beam-level early) synchronization for seamless mobility as illustrated in FIG. 17 is via (UE and/or network sides') signaling(s) of TCI state(s) e.g. via (unified) TCI state(s) indication(s) and/or TCI state(s) activation/deactivation MAC CE command.

For Mode A, Mode B and/or Mode C as specified/defined herein in the present disclosure, a first message could correspond to or could be equivalent to or could be replaced by/with or could be used in an exchangeable manner with transmission of a first message, a first message transmission, a first message transmission occasion, a PUCCH resource of the first UL channel, a first message transmission (occasion) via/in/by a PUCCH resource of the first UL channel and/or etc. throughout the present disclosure; and/or, a second message could correspond to or could be equivalent to or could be replaced by/with or could be used in an exchangeable manner with transmission of a second message, a second message transmission, a second message transmission occasion, a PUSCH resource of the second UL channel, a second message transmission (occasion) via/in/by a PUSCH resource of the second UL channel and/or etc. throughout the present disclosure. For instance, a second message associated/specific to a first message could be equivalent to a PUSCH resource of the second UL channel that carries or conveys the second message associated/specific to a PUCCH resource of the first UL channel that carries or conveys the first message, and/or a/the second message transmission occasion of a PUSCH resource of the second UL channel associated/specific to a/the first message transmission occasion of a PUCCH resource of the first UL channel.

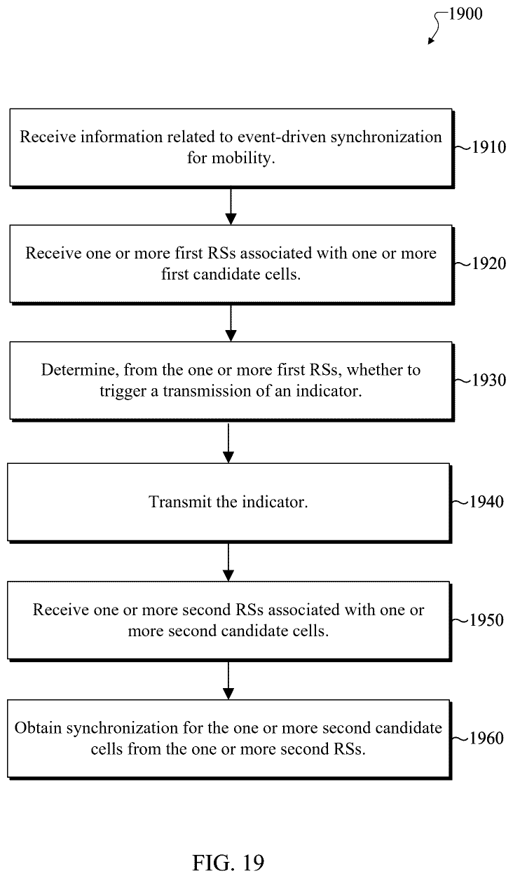

FIG. 19 illustrates an example method 1900 performed by a UE in a wireless communication system according to embodiments of the present disclosure. The method 1900 of FIG. 19 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1900 is for illustration only and other embodiments can be used without departing from the scope of the present disclosure.

The method 1900 begins with the UE receiving information related to event-driven synchronization for mobility (1910). The UE then receives one or more first reference signals (RSs) associated with one or more first candidate cells (1920). In various embodiments, the information includes configurations for the first candidate cells and the one or more first RSs are SS/PBCH blocks. The UE then determines, from the one or more first RSs, whether to trigger a transmission of an indicator (1930). The UE then transmits the indicator (1940). For example, in 1940, the UE transmits the indicator in response to a determination to trigger the indicator. In various embodiments, the information includes a PUCCH resource and the indicator is transmitted on the PUCCH resource.

The UE then receives one or more second RSs associated with one or more second candidate cells (1950). In various embodiments, the one or more second RSs are SS/PBCH blocks, the one or more second RSs are received within a time duration, T_gap, after completion of transmission of the indicator, and T_gap is higher layer configured. In various embodiments, the one or more second RSs are SS/PBCH blocks quasi-co-located with reference signals in one or more TCI states from a TCI states activation/deactivation command, the TCI states activation/deactivation command is received within a time duration, T_gap, after completion of transmission of the indicator, and T_gap is higher layer configured. In various embodiments, the one or more second candidate cells are a subset of the first candidate cells. The UE then obtains synchronization for the one or more second candidate cells from the one or more second RSs (1960). In various embodiments, the indicator is to indicate transmission of a report and the UE transmits the report including information related to the one or more second candidate cells.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive information related to event-driven synchronization for mobility; and
receive one or more first reference signals (RSs) associated with one or more first candidate cells; and
a processor operably coupled with the transceiver, the processor configured to determine, from the one or more first RSs, whether to trigger a transmission of an indicator,
wherein the transceiver is further configured to:
in response to a determination to trigger the transmission, transmit the indicator; and
receive one or more second RSs associated with one or more second candidate cells, and
wherein the processor is further configured to obtain, from the one or more second RSs, synchronization for the one or more second candidate cells.

2. The UE of claim 1, wherein:
the information includes configurations for the first candidate cells; and
the one or more first RSs are synchronization signal/physical broadcast channel (SS/PBCH) blocks.

3. The UE of claim 1, wherein:
the information includes a physical uplink control channel (PUCCH) resource; and
the indicator is transmitted on the PUCCH resource.

4. The UE of claim 1, wherein:
the one or more second RSs are synchronization signal/physical broadcast channel (SS/PBCH) blocks,
the one or more second RSs are received within a time duration, T_gap, after completion of transmission of the indicator, and
T_gap is higher layer configured.

5. The UE of claim 1, wherein:
the one or more second RSs are synchronization signal/physical broadcast channel (SS/PBCH) blocks quasi-co-located with reference signals in one or more transmission configuration indication (TCI) states from a TCI states activation/deactivation command,
the TCI states activation/deactivation command is received within a time duration, T_gap, after completion of transmission of the indicator, and
T_gap is higher layer configured.

6. The UE of claim 1, wherein the one or more second candidate cells are a subset of the first candidate cells.

7. The UE of claim 1, wherein:
the indicator is to indicate transmission of a report, and
the transceiver is further configured to transmit the report including information related to the one or more second candidate cells.

8. A base station (BS), comprising:
a processor; and
a transceiver operably coupled with the processor, the transceiver configured to:
transmit information related to event-driven synchronization for mobility;
transmit one or more first reference signals (RSs) associated with one or more first candidate cells;
receive an indicator, wherein transmission of the indicator is triggered based on the one or more RSs; and
transmit one or more second RSs associated with one or more second candidate cells, wherein the one or more second RSs indicate synchronization information for the one or more second candidate cells.

9. The BS of claim 8, wherein:
the information includes configurations for the first candidate cells; and
the one or more first RSs are synchronization signal/physical broadcast channel (SS/PBCH) blocks.

10. The BS of claim 8, wherein:
the information includes a physical uplink control channel (PUCCH) resource; and
the indicator is received on the PUCCH resource.

11. The BS of claim 8, wherein:
the one or more second RSs are synchronization signal/physical broadcast channel (SS/PBCH) blocks,
the one or more second RSs are transmitted within a time duration, T_gap, after completion of reception of the indicator, and
T_gap is higher layer configured.

12. The BS of claim 8, wherein:
the one or more second RSs are synchronization signal/physical broadcast channel (SS/PBCH) blocks quasi-co-located with reference signals in one or more transmission configuration indication (TCI) states from a TCI states activation/deactivation command,
the TCI states activation/deactivation command is transmitted within a time duration, T_gap, after completion of reception of the indicator, and
T_gap is higher layer configured.

13. The BS of claim 8, wherein the one or more second candidate cells are a subset of the first candidate cells.

14. The BS of claim 8, wherein:
the indicator is to indicate transmission of a report, and
the transceiver is further configured to receive the report including information related to the one or more second candidate cells.

15. A method performed by a user equipment (UE), the method comprising:
receiving information related to event-driven synchronization for mobility;
receiving one or more first reference signals (RSs) associated with one or more first candidate cells;
determining, from the one or more first RSs, whether to trigger a transmission of an indicator;
in response to a determination to trigger the transmission, transmitting the indicator;
receiving one or more second RSs associated with one or more second candidate cells; and
obtaining, from the one or more second RSs, synchronization for the one or more second candidate cells.

16. The method of claim 15, wherein:
the information includes configurations for the first candidate cells; and
the one or more first RSs are synchronization signal/physical broadcast channel (SS/PBCH) blocks.

17. The method of claim 15, wherein:
the information includes a physical uplink control channel (PUCCH) resource; and
the indicator is transmitted on the PUCCH resource.

18. The method of claim 15, wherein:
the one or more second RSs are synchronization signal/physical broadcast channel (SS/PBCH) blocks,
the one or more second RSs are received within a time duration, T_gap, after completion of transmission of the indicator, and
T_gap is higher layer configured.

19. The method of claim 15, wherein:
the one or more second RSs are synchronization signal/physical broadcast channel (SS/PBCH) blocks quasi-co-located with reference signals in one or more transmission configuration indication (TCI) states from a TCI states activation/deactivation command,
the TCI states activation/deactivation command is received within a time duration, T_gap, after completion of transmission of the indicator, and
T_gap is higher layer configured.

20. The method of claim 15, wherein the one or more second candidate cells are a subset of the first candidate cells.
